(19) United States
(12) Patent Application Publication
(10) Pub. No.: US 2023/0074106 A1
(43) Pub. Date: Mar. 9, 2023

(54) COMBINATION PREPARATION PROCESS AND COMBINATION PREPARATION SYSTEM FOR ZIRCONIA AND METHYLCHLOROSILANE AND/OR POLYSILICON

(71) Applicants: XINTE ENERGY CO., LTD., Urumqi, Xinjiang (CN); XINJIANG JINGSHUO NEW MATERIALS CO., LTD., Urumqi, Xinjiang (CN)

(72) Inventors: Bo YIN, Urumqi, Xinjiang (CN); Bin HUANG, Urumqi, Xinjiang (CN); Xiecheng FAN, Urumqi, Xinjiang (CN); Guohui CHEN, Urumqi, Xinjiang (CN); Zhufeng WU, Urumqi, Xinjiang (CN); Xingping LIU, Urumqi, Xinjiang (CN)

(21) Appl. No.: 17/642,155

(22) PCT Filed: Dec. 3, 2019
(86) PCT No.: PCT/CN2019/122688

§ 371 Date: Oct. 4, 2022

(30) Foreign Application Priority Data
Dec. 11, 2018 (CN) 201811510146.5

(51) Int. Cl. C01G 25/02; C07F 7/16

(52) U.S. Cl. CPC C01G 25/02; C07F 7/16

(57) ABSTRACT

Disclosed is a combined process for preparing zirconium oxide, methyl chlorosilane and/or polycrystalline silicon and a combined system comprising: preparing zirconium oxide by using zircon sand, carbon, chlorine gas, silicon, and hydrogen chloride as raw materials, the products separated during preparing zirconium oxide include gas phase products and liquid phase products, methyl chlorosilane is prepared from the gas phase separated during preparing zirconium oxide, and polycrystalline silicon is prepared by using the liquid phase products as raw materials. In this invention, not only carbon monoxide, hydrogen chloride and other waste gases generated are used as raw materials for producing methyl chlorosilane, but also a by-product silicon tetrachloride generated is used as a raw material for producing polycrystalline silicon, thereby effectively recycling waste gases and silicon tetrachloride, reducing the treatment cost of waste gases and silicon tetrachloride and the production cost of methyl chlorosilane and polycrystalline silicon, and avoiding environmental pollution.

This application claims the priority of Chinese Patent Application No. CN201811510146.5 filed on Dec. 11, 2018, with a title of “A Combined Process for Preparing Zirconium Oxide, Methyl Chlorosilane and/or polycrystalline silicon, and a Combined System”, which is hereby incorporated by reference in its entirety.

### FIELD OF THE INVENTION

The present invention belongs to the technical field for producing zirconium oxide and silicone monomers, and particularly relates to a combined process for preparing zirconium oxide, methyl chlorosilane and/or polycrystalline silicon, and a combined system.

### BACKGROUND OF THE INVENTION

Zirconium dioxide (ZrO₂) is an important ceramic material with excellent properties such as high temperature resistance, wear resistance and corrosion resistance. In addition to being used in refractory materials and ceramic pigments, it has become an important raw material for electronic ceramics, functional ceramics and artificial gemstones, and is increasingly widely used in high-tech fields. Zirconium tetrachloride is a basic raw material for preparing zirconium oxide, and the preparation process of zirconium tetrachloride is also a key step in the preparation of zirconium oxide. A large amount of CO tail gas will be generated during preparing zirconium tetrachloride by the chlorination method. During the preparation process of zirconium oxide, a large amount of waste acid solution will be generated, and the direct discharge will cause environmental pollution on the one hand, and waste resources on the other hand.

### SUMMARY OF THE INVENTION

In order to solve the above-mentioned defects in the prior art, the present disclosure provides a combined process for preparing zirconium oxide and methyl chlorosilane and/or a polycrystalline silicon, and a combined system, the combined process can use waste gases such as carbon monoxide and hydrogen chloride generated during preparing zirconium oxide as raw materials for producing methyl chlorosilane, so as to allow the waste gases to be effectively recycled with high value, which further reduces the treatment cost of the waste gases and the production cost of methyl chlorosilane. At the same time, silicon tetrachloride liquid phase product generated during preparing zirconium oxide can also be used as a raw material for producing polycrystalline silicon.

In a first aspect, the present disclosure provides a combined process for preparing zirconium oxide and methyl chlorosilane, comprising:

preparing zirconium oxide by using zircon sand, a reducing agent carbon, chlorine gas, a heat supplementing agent silicon and hydrogen chloride as raw materials, and products separated during preparing zirconium oxide include gas phase products and liquid phase products, and said gas phase products include carbon monoxide, hydrogen gas and hydrogen chloride; and

preparing methyl chlorosilane by using the separated gas phase products during preparing zirconium oxide as raw materials.

Preferably, the combined process specifically comprises the following steps:

mixing and heating zircon sand, the reducing agent carbon, chlorine gas, the heat supplementing agent silicon and hydrogen chloride in a first reactor, wherein zircon sand, the reducing agent carbon and chlorine gas react to generate zirconium tetrachloride, silicon tetrachloride and carbon monoxide; the heat supplementing agent silicon, chlorine gas and hydrogen chloride react to generate silicon tetrachloride and hydrogen gas, so as to yield a first gas phase mixture;

removing hydrogen chloride and chlorine gas from the first gas phase mixture by passing the first gas phase mixture through silicon powder in a dechlorinator;

cooling the first gas phase mixture from which hydrogen chloride and chlorine gas have been removed to separate a crude zirconium tetrachloride solid; hydrolyzing the crude zirconium tetrachloride solid to generate zirconium oxychloride, so as to yield a hydrolysis mixture; then subjecting the hydrolysis mixture to evaporation, crystallization and solid-liquid separation to yield solid zirconium oxychloride; and heating the solid zirconium oxychloride in a second reactor to yield zirconium oxide;

scrubbing the first gas phase mixture from which the crude zirconium tetrachloride solid has been removed by using silicon tetrachloride as a scrubbing solution to recovery silicon tetrachloride therein, so as to yield a second gas phase mixture comprising carbon monoxide and hydrogen gas;

introducing the second gas phase mixture into a third reactor; pressurizing and heating to make reaction and generate methanol, so as to yield a third gas phase mixture;

introducing the third gas phase mixture into a fourth reactor, and introducing hydrogen chloride into the fourth reactor, heating to make methanol react with hydrogen chloride to generate methane chloride, so as to yield a fourth gas phase mixture;

introducing the fourth gas phase mixture into a fifth reactor, and introducing silicon powder into the fifth reactor, heating to make methane chloride react with the silicon powder to generate methyl chlorosilane, so as to yield a fifth gas phase mixture.

Preferably, the combined process further comprises the following steps:

detecting a molar ratio of carbon to hydrogen in the gases introduced into the third reactor by a hydrocarbon detector, when a detected molar ratio of carbon to hydrogen is greater than a preset molar ratio of carbon to hydrogen, hydrogen gas is introduced into the third reactor, until the molar ratio of carbon to hydrogen in the gases introduced into the third reactor is equal to the preset molar ratio of carbon to hydrogen; when a detected molar ratio of carbon to hydrogen is less than the preset molar ratio of carbon to hydrogen, amount of hydrogen chloride introduced into a first reactor is reduced, until the molar ratio of carbon to hydrogen in the gases introduced into the third reactor is equal to the preset molar ratio of carbon to hydrogen.

Preferably, the preset molar ratio of carbon to hydrogen is 1:4 to 1:5.

Preferably, the third reactor has a pressure of 5.0 MPa to 6.0 MPa, and a heating temperature of 220° C. to 250° C.

Preferably, the combined process further comprises the following steps:

introducing one or more of the gas phase products produced by evaporation of the hydrolysis mixture and crystallization of the hydrolysis mixture into a stripping tower to stripe hydrogen chloride, and then the stripped hydrogen chloride is used as a source of hydrogen chloride for introducing into the fourth reactor.

Preferably, said stripping tower has a stripping temperature of 40° C. to 60° C., and a pressure of 0.1 MPa to 0.3 MPa.

Preferably, the combined process further comprises the following steps:

introducing gas phase products produced by evaporation of the hydrolysis mixture into a heat exchanger as a heat source: introducing the hydrolysis mixture into the heat exchanger for raising temperature by heat exchange, then evaporating the hydrolysis mixture after raising temperature by heat exchange; introducing the gas phase products produced by evaporating the hydrolysis mixture into the heat exchanger for lowering temperature by heat exchange, after that introducing the gas phase products into the stripping tower for stripping.

Preferably, the combined process further comprises the following steps:

cooling hydrogen chloride discharged from a gas phase outlet of the stripping tower to separate water therein, and introducing hydrogen chloride from which water has been removed into the fourth reactor.

Preferably, before subjecting the hydrolysis mixture to evaporation, crystallization, and solid-liquid separation to yield solid zirconium oxychloride, the combined process further comprises the following steps:

subjecting the hydrolysis mixture to solid-liquid separation to remove solid impurities therein.

Preferably, before introducing the second gas phase mixture into the third reactor, the combined process further comprises the following steps:

cooling the second gas phase mixture to separate silicon tetrachloride liquid, so as to yield purified second gas phase products.

Preferably, the combined process further comprises the following steps:

the silicon tetrachloride liquid separated by cooling the second gas phase mixture is used as a cold source for the step of cooling and separating the crude zirconium tetrachloride solid from the first gas phase mixture; and/or,

the silicon tetrachloride liquid separated by cooling the second gas phase mixture is used as a scrubbing solution for the step of scrubbing the first gas phase mixture, from which silicon tetrachloride has been separated, to remove silicon tetrachloride.

Preferably, before introducing the third gas phase mixture into the fourth reactor, the combined process further comprises the following steps:

cooling the third gas phase mixture to yield crude methanol, and purifying the crude methanol by rectification to yield purified third gas phase products.

Preferably, before introducing the fourth gas phase mixture into the fifth reactor, the combined process further comprises the following steps:

scrubbing and cooling the fourth gas phase mixture by using water as a scrubbing solution to remove methanol and hydrogen chloride, and then drying to remove water, so as to yield purified fourth gas phase products.

Preferably, the first reactor has a heating temperature of 1050° C. to 1200° C., and/or the second reactor has a heating temperature of 800° C. to 1000° C.

Preferably, the fourth reactor has a heating temperature of 130° C. to 150° C.

Preferably, the fifth reactor has a heating temperature of 280° C. to 320° C.

Preferably, the combined process further comprises the following steps:

returning liquid produced by evaporation, crystallization and solid-liquid separation of the hydrolysis mixture to the hydrolysis mixture which is produced by hydrolyzing the crude zirconium tetrachloride solid to generate zirconium oxychloride, and then subjecting the hydrolysis mixture to evaporation, crystallization and solid-liquid separation.

In a second aspect, the present disclosure also provides a combined process for preparing zirconium oxide, methyl chlorosilane and polycrystalline silicon, said liquid phase products separated during the above-mentioned combined process for preparing zirconium oxide and methyl chlorosilane comprises silicon tetrachloride, and said silicon tetrachloride is used as a raw material to prepare polycrystalline silicon.

Preferably, according to the above-mentioned combined process for preparing zirconium oxide and methyl chlorosilane, it further comprises the following steps:

using silicon tetrachloride liquid phase products separated during preparing zirconium oxide as a raw material to prepare polycrystalline silicon, which comprises firstly performing a hydrochlorination with said silicon tetrachloride to yield trichlorosilane, and then performing a hydrogen reduction reaction with the trichlorosilane to yield polycrystalline silicon.

In a third aspect, the present disclosure also provides a combined system for preparing zirconium oxide and methyl chlorosilane used in the above combined process, including:

a zirconium oxide preparation device, which is used to prepare zirconium oxide with zircon sand, a reducing agent carbon, chlorine gas, a heat supplementing agent silicon and hydrogen chloride as raw materials, and is also used to separate gas phase products of carbon monoxide, hydrogen gas and hydrogen chloride produced during preparing zirconium oxide;

a methyl chlorosilane preparation device, which is connected with said zirconium oxide preparation device, and is used to prepare methyl chlorosilane with gas phase products of carbon monoxide, hydrogen gas and hydrogen chloride separated from said zirconium oxide preparation device as raw materials.

Preferably,

the zirconium oxide preparation device includes a first reactor, a dechlorinator, a first cooling separator, a hydrolysis tank, an evaporator, a crystallizer, a first solid-liquid separator, a second reactor, and a scrubbing tower,

the methyl chlorosilane preparation device includes a third reactor, a fourth reactor, and a fifth reactor;

said first reactor is used to mix and heat zircon sand, a reducing agent carbon, chlorine gas, a heat supplementing agent silicon, and hydrogen chloride, allow zircon sand, the reducing agent carbon, and chlorine gas to react to generate zirconium tetrachloride, silicon tetrachloride and carbon monoxide; and allow the heat supplementing agent silicon, chlorine gas, hydrogen chloride to react to generate silicon tetrachloride, hydrogen gas, so as to yield the first gas phase mixture;

said dechlorinator is arranged between said first reactor and said first cooling separator, and said dechlorinator is connected with said first reactor and said first cooling separator, respectively; alternatively, said dechlorinator is arranged in said first reactor, and separates a first reaction chamber provided in the first reactor from outlet of the first reactor, and the dechlorinator is used to remove chlorine gas, hydrogen chloride in the first gas phase mixture by using silicon power therein;

said first cooling separator is connected with said first reactor, and is used to cool the introduced first gas phase mixture from which hydrogen chloride and chlorine have been removed, so as to separate the crude zirconium tetrachloride solid and produce a first gas phase mixture without crude zirconium tetrachloride solid;

said hydrolysis tank is connected with said first cooling separator, and said crude zirconium tetrachloride solid is introduced into the hydrolysis tank and then is hydrolyzed to generate zirconium oxychloride, so as to yield a hydrolysis mixture;

said evaporator is connected with said hydrolysis tank, and said hydrolysis mixture is introduced into the evaporator for evaporation;

said crystallizer is connected with said evaporator, and the hydrolysis mixture after evaporation is introduced into the crystallizer for crystallization;

said first solid-liquid separator is connected with said crystallizer, and the hydrolysis mixture after crystallization is introduced into the first solid-liquid separator for solid-liquid separation, so as to yield solid zirconium oxychloride;

said second reactor is connected with said first solid-liquid separator, and solid zirconium oxychloride is introduced into the second reactor and heated to yield zirconium oxide;

said scrubbing tower is connected with said first cooling separator, and the first gas phase mixture from which the crude zirconium tetrachloride solid has been removed is scrubbed by using silicon tetrachloride as a scrubbing solution to recovery silicon tetrachloride liquid, so as to yield a second gas phase mixture comprising carbon monoxide and hydrogen gas;

said third reactor is connected with said scrubbing tower, and said second gas phase mixture is introduced into the third reactor, and is pressurized and heated to make the second gas phase mixture react and generate methanol, so as to yield the third gas phase mixture;

said fourth reactor is connected with said third reactor, said third gas phase mixture is introduced into the fourth reactor; hydrogen chloride is introduced into the fourth reactor; and both of them is heated to make methanol react with hydrogen chloride and to generate methane chloride, so as to yield a fourth gas phase mixture;

said fifth reactor is connected with said fourth reactor, said fourth gas phase mixture is introduced into the fifth reactor, silicon powder is introduced into the fifth reactor, and both of them is heated to make methane chloride react with silicon powder and to generate methyl chlorosilane, so as to yield a fifth gas phase mixture.

Preferably, the methyl chlorosilane preparation device further comprises:

a hydrogen pipeline connected with an inlet of said third reactor, wherein said hydrogen pipeline is used for introducing hydrogen into the third reactor, and said hydrogen pipeline is provided with a first valve;

a hydrogen chloride pipeline connected with an inlet of said first reactor, wherein said hydrogen chloride pipeline is used for introducing hydrogen chloride into the first reactor, and said hydrogen chloride pipeline is provided with a second valve;

a hydrocarbon detector for detecting the molar ratio of carbon to hydrogen in the gases introduced into said third reactor;

a controller for receiving a molar ratio value of carbon to hydrogen in the gases in said third reactor detected by said hydrocarbon detector, when the molar ratio of carbon to hydrogen detected by the hydrocarbon detector is greater than a preset molar ratio of carbon to hydrogen, the controller open the first valve to introduce hydrogen gas into the third reactor, until the molar ratio of carbon to hydrogen in the gases introduced into the third reactor is equal to the preset molar ratio of carbon to hydrogen, and then the controller close the first valve; when the molar ratio of carbon to hydrogen detected by the hydrocarbon detector is less than the preset molar ratio of carbon to hydrogen, the controller close the second valve to reduce the amount of hydrogen chloride introduced into a first reactor, until the molar ratio of carbon to hydrogen in the gases introduced into the third reactor is equal to the preset molar ratio of carbon to hydrogen, and then the controller open the second valve.

Preferably, the methyl chlorosilane preparation device further includes:

a stripping tower, and a gas outlet of said stripping tower is connected with the inlet of said fourth reactor,

an inlet of said stripping tower is connected with said evaporator, and gas phase products evaporated by the evaporator is introduced into the stripping tower to strip hydrogen chloride, and the stripped hydrogen chloride is introduced into said fourth reactor as a source of hydrogen chloride; and/or,

the inlet of said stripping tower is connected with said crystallizer, and gas phase crystallized by the crystallizer is introduced into the stripping tower to strip hydrogen chloride, and the stripped hydrogen chloride is introduced into said fourth reactor as a source of hydrogen chloride.

Preferably, the methyl chlorosilane preparation device further includes:

a heat exchanger, which is connected with said stripping tower and also connected with said evaporator, and the gas phase products produced by evaporating the hydrolysis mixture through the evaporator is introduced into the heat exchanger as a heat source, and the hydrolysis mixture is introduced into the heat exchanger for raising temperature by heat exchange, and then the gas phase products produced by evaporating the hydrolysis mixture are introduced into the heat exchanger for lowering temperature by heat exchange, after that the gas phase products are introduced into the stripping tower for stripping.

Preferably, the methyl chlorosilane preparation device further includes:

a cooling separator on the top of the stripping tower, wherein an inlet of the cooling separator on the top of the stripping tower is connected with the gas outlet of the stripping tower, a liquid outlet of the cooling separator on the top of the stripping tower is connected with the inlet on the top of the stripping tower, and a gas outlet of the cooling separator on the top of the tower is connected with said fourth reactor, and the cooling separator on the top of the stripping tower is used for cooling and separating water, and the cooled and separated water flows back into the stripping tower, and hydrogen chloride from which water has been removed flows into the fourth reactor.

Preferably, said zirconium oxide preparation device further includes:

a second solid-liquid separator, wherein an inlet of said second solid-liquid separator is connected with an outlet of said hydrolysis tank, an outlet of the second solid-liquid separator is connected with an inlet of said evaporator, and the hydrolysis mixture through the hydrolysis tank is introduced into the second solid-liquid separator for performing solid-liquid separation to remove solid impurities, and then flows into the evaporator.

Preferably, said zirconium oxide preparation device further includes:

a first cooler arranged between said scrubbing tower and said third reactor, wherein an inlet of said first cooler is connected with a gas outlet of the scrubbing tower, a gas outlet of the first cooler is connected with an inlet of the third reactor, and the first cooler is used for cooling the second gas phase mixture to separate the silicon tetrachloride liquid, so as to yield purified second gas phase products.

Preferably, a liquid outlet of said first cooler is connected with the inlet of said first cooling separator, and the silicon tetrachloride liquid separated from the second gas phase mixture is introduced into the first cooling separator as a cold source to cool the first gas phase mixture to separate the crude zirconium tetrachloride solid; and/or,

a liquid outlet of said first cooler is connected with an scrubbing solution inlet of the scrubbing tower, and the silicon tetrachloride liquid separated by cooling the second gas phase mixture is introduced into the scrubbing tower for scrubbing to recover the silicon tetrachloride.

Preferably, said methyl chlorosilane preparation device further includes:

a second cooler connected with said third reactor, wherein the third gas phase mixture enters said second cooler for cooling to yield crude methanol;

a rectification tower arranged between said second cooler and said fourth reactor, wherein the rectification tower is connected with the second cooler and the fourth reactor respectively, and crude methanol is introduced into the rectification tower for purification to yield purified third gas phase products.

Preferably, said methyl chlorosilane preparation device further includes:

a scrubbing and cooling tower connected with said fourth reactor, wherein the fourth gas phase mixture enters said scrubbing and cooling tower and uses water as a scrubbing solution to scrubbing and cool to remove methanol and hydrogen chloride;

a drying tower arranged between said scrubbing and cooling tower and said fifth reactor, wherein the drying tower is used to dry and remove the by-product dimethyl ether during reaction of water, methanol and hydrogen chloride for generating methyl chlorosilane, so as to yield purified fourth gas phase products.

Preferably, a liquid outlet of said first solid-liquid separator is connected with an inlet of said hydrolysis tank, and the liquid in the first solid-liquid separator flows into the hydrolysis tank.

In a fourth aspect, the present disclosure also provides a combined system for preparing zirconium oxide, methyl chlorosilane and polycrystalline silicon, besides the system used for the combined process for preparing zirconium oxide and methyl chlorosilane used in the above process, it further includes:

a polycrystalline silicon preparation device, which is connected with said zirconium oxide preparation device and is used for preparing polycrystalline silicon by using the silicon tetrachloride separated by said zirconium oxide preparation device as a raw material.

Compared with the prior art, the present disclosure has the following beneficial effects:

With the combined process for preparing zirconium oxide, methyl chlorosilane and polycrystalline silicon, and the combined system provided in the present disclosure, not only carbon monoxide, hydrogen chloride and other waste gases generated during preparing zirconium oxide are used as raw materials for producing methyl chlorosilane, but also silicon tetrachloride, a by-product generated during preparing zirconium oxide, is used as a raw material for producing polycrystalline silicon, so that both waste gases and silicon tetrachloride can be effectively recycled with high value, which reduces the treatment cost of waste gases and silicon tetrachloride, avoids environmental pollution, reduces the production cost of methyl chlorosilane and polycrystalline silicon, and improves the technological level as well as the comprehensive economic benefits.

### BRIEF DESCRIPTION OF THE DRAWINGS

FIG. 1 is a schematic structural diagram of the combined system for preparing zirconium oxide, methyl chlorosilane and/or polycrystalline silicon provided in Example 2 of the present disclosure;

FIG. 2 is a schematic structural diagram of the combined system for preparing zirconium oxide and methyl chlorosilane and/or polycrystalline silicon provided in Example 3 of the present disclosure;

FIG. 3 is a flow chart of the combined process for preparing zirconium oxide, methyl chlorosilane and/or polycrystalline silicon provided in Example 2 of the present disclosure.

In the figures: 1—first reactor; 2—first cooling separator; 3—hydrolysis tank; 4—evaporator; 5—crystallizer; 6—first solid-liquid separator; 7—second reactor; 8—scrubbing tower; 9—third reactor; 10—fourth reactor; 11—fifth reactor; 12—third cooler; 13—third storage tank; 14—hydrogen gas pipeline; 15—hydrocarbon detector; 16—first valve; 17—stripping tower; 18—heat exchanger; 19—stripping tower kettle reboiler; 20—second solid-liquid separator; 21—first cooler; 22—first storage tank; 23—first transfer pump; 24—compressor; 25—second cooler; 26—rectification tower; 27—second storage tank; 28—second transfer pump; 29—scrubbing and cooling tower; 30—drying tower; 31—heater; 32—beater; 33—centrifugal separator; 34—cooling separator on the top of stripping tower; 35—dechlorinator; 36—first reaction chamber; 37—outlet of the first reactor; 38—hydrogen chloride pipeline; 39—inlet of the first reactor; 40—second valve.

### DETAILED DESCRIPTION OF THE PREFERRED EMBODIMENTS

In order to make those skilled in the art better understand the technical solutions of the present disclosure, the present disclosure will be further described in detail below with reference to the accompanying drawings and examples.

Examples of the present invention are described in detail below, examples of which are illustrated in the accompanying drawings, wherein the same or similar reference numerals refer to the same or similar elements or elements having the same or similar functions throughout. The examples described below with reference to the accompanying drawings are exemplary and are only used to explain the present invention, but should not be construed as a limitation on the present invention.

### Example 1

The example of the present disclosure provides a combined system for preparing zirconium oxide and methyl chlorosilane, comprising:

a zirconium oxide preparation device, which is used to prepare zirconium oxide with zircon sand, a reducing agent carbon, chlorine gas, a heat supplementing agent silicon and hydrogen chloride as raw materials, and the zirconium oxide preparation device is also used to separate gas phase products of carbon monoxide, hydrogen gas and hydrogen chloride produced during preparing zirconium oxide;

a methyl chlorosilane preparation device, which is connected with zirconium oxide preparation device, and is used to prepare methyl chlorosilane with gas phase products of carbon monoxide, hydrogen gas and hydrogen chloride separated from zirconium oxide preparation device as raw materials.

The example of the present disclosure also provide a combined process for preparing zirconium oxide and methyl chlorosilane using the above-mentioned combined system for preparing zirconium oxide and methyl chlorosilane, comprising:

preparing zirconium oxide by using zircon sand, a reducing agent carbon, chlorine gas, a heat supplementing agent silicon and hydrogen chloride as raw materials, gas phase products separated during preparing zirconium oxide include gas phase products of carbon monoxide, hydrogen gas and hydrogen chloride; and

preparing methyl chlorosilane by using the separated gas phase products during preparing zirconium oxide as the raw materials.

In the example of the present disclosure, carbon monoxide and hydrogen chloride generated during preparing zirconium oxide are used as raw materials for producing methyl chlorosilane, so that both waste gases and silicon tetrachloride can be effectively recycled with high value, which reduces the treatment cost of waste gases and silicon tetrachloride, avoids environmental pollution, reduces the production cost of methyl chlorosilane and polycrystalline silicon, and improves the technological level as well as the comprehensive economic benefits.

### Example 2

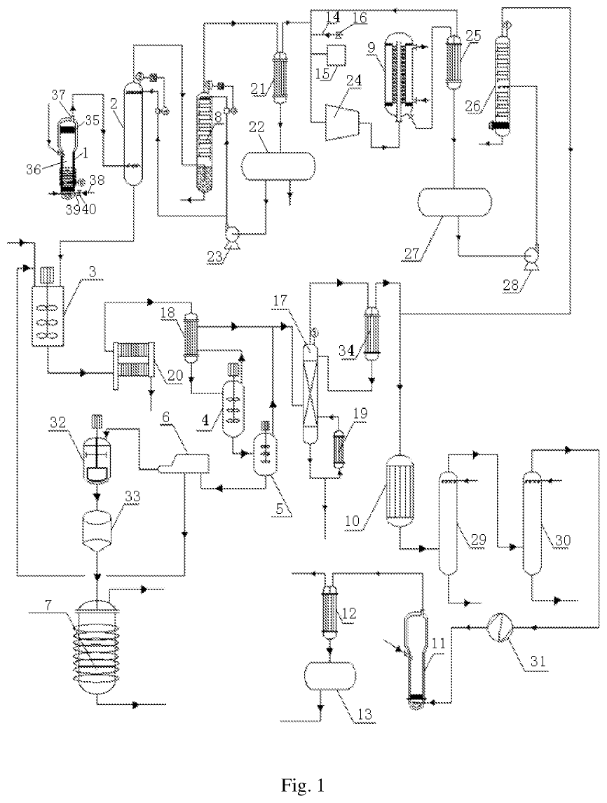

As shown in FIG. 1, an example of the present disclosure provides a combined system used for the combined process for preparing zirconium oxide and methyl chlorosilane, comprising:

a zirconium oxide preparation device, which is used to prepare zirconium oxide with zircon sand, a reducing agent carbon, chlorine gas, a heat supplementing agent silicon and hydrogen chloride as raw materials, and the zirconium oxide preparation device is also used to separate gas phase products of carbon monoxide, hydrogen gas and hydrogen chloride produced during preparing zirconium oxide;

a methyl chlorosilane preparation device, which is connected with zirconium oxide preparation device, and is used to prepare methyl chlorosilane with gas phase products of carbon monoxide, hydrogen gas and hydrogen chloride separated from zirconium oxide preparation device as raw materials

Furthermore, the zirconium oxide preparation device in the present example includes: a first reactor 1, a dechlorinator 35, a first cooling separator 2, a hydrolysis tank 3, an evaporator 4, a crystallizer 5, a first solid-liquid separator 6, a second reactor 7 and a scrubbing tower 8.

Zircon sand, the reducing agent carbon, chlorine gas, the heat supplementing agent silicon and hydrogen chloride are mixed and heated in the first reactor 1, wherein zircon sand, the reducing agent carbon and chlorine gas react to generate zirconium tetrachloride, silicon tetrachloride and carbon monoxide; the heat supplementing agent silicon, chlorine gas and hydrogen chloride react to generate silicon tetrachloride and hydrogen gas, so as to yield a first gas phase mixture;

Specifically, the first reactor 1 is provided with one or more gas inlet(s) for introducing chlorine gas and hydrogen chloride. The first reactor 1 is also provided with one or more feeding port(s) for adding zircon sand, the reducing agent carbon, and the heat supplementing agent silicon. In the present example, the interior of the first reactor 1 includes a first reaction chamber 36, and the first reaction chamber 36 is preferably disposed at the lower portion of the interior of the first reactor 1. The first reactor 1 should also have heating function for heating the first reaction chamber 36, and has a heating temperature of 1050° C. to 1200° C.

The dechlorinator 35 is arranged in the first reactor 1, and separates the first reaction chamber 36 provided the first reactor 1 from an outlet 37 of the first reactor. The dechlorinator 35 is provided with silicon powder to remove chlorine gas and hydrogen chloride in the first gas phase mixture by passing the first gas phase mixture through silicon powder in a dechlorinator 35.

The first cooling separator 2 is connected with the first reactor 1, and is used to cool the introduced first gas phase mixture from which hydrogen chloride and chlorine gas have been removed, so as to separate crude zirconium tetrachloride solid and produce a first gas phase mixture without crude zirconium tetrachloride solid; the tower top of the first cooling separator 2 is provided with a first temperature detection device and a first reflux scrubbing solution flow control device, the first temperature detection device and the first reflux scrubbing solution flow control device are connected in a cascade loop to control the first cooling separator to maintain an appropriate cooling temperature. In the present example, the first cooling separator 2 preferably has a heating temperature of 180° C. to 250° C.

The hydrolysis tank 3 is connected with the first cooling separator 2, and crude zirconium tetrachloride solid is introduced into the hydrolysis tank 3 and then is hydrolyzed to generate zirconium oxychloride, so as to yield a hydrolysis mixture. In the present example, the hydrolysis tank 3 is made of graphite.

The evaporator 4 is connected with the hydrolysis tank 3, and the hydrolysis mixture is introduced into the evaporator 4 for evaporation. In the present example, the evaporator 4 is made of graphite.

The crystallizer 5 is connected with the evaporator 4, and the hydrolysis mixture after evaporation is introduced into the crystallizer 5 for crystallization. In the present example, the crystallizer 5 is made of glass lining material.

The first solid-liquid separator 6 is connected with the crystallizer 5, and the hydrolysis mixture after crystallization is introduced into the first solid-liquid separator 6 for solid-liquid separation, so as to yield solid zirconium oxychloride; Specifically, the solid-liquid separator 6 in the present example is a belt filter, preferably, the belt filter is a vacuum belt filter.

The second reactor 7 is connected with the first solid-liquid separator 6, and solid zirconium oxychloride is introduced into the second reactor 7 and heated to yield zirconium oxide. In the present example, the second reactor 7 may have a heating temperature of 800° C. to 1000° C.

The scrubbing tower 8 is connected with the first cooling separator 2, and the first gas phase mixture from which the crude zirconium tetrachloride solid has been removed is introduced into the scrubbing tower 8, then it is scrubbed by using silicon tetrachloride as a scrubbing solution to recovery silicon tetrachloride liquid, so as to yield a second gas phase mixture comprising carbon monoxide and hydrogen gas. In the present example, the scrubbing tower 8 is a sieve tray tower, and the scrubbing tower 8 preferably adopts silicon tetrachloride as a scrubbing solution. The top of the scrubbing tower 8 is provided with a second temperature detection device and a second scrubbing solution flow control device, and the second temperature detection device and the second scrubbing solution flow control device are connected in a cascade loop to control the scrubbing tower 8 to maintain an appropriate cooling temperature. In the present example, the scrubbing tower 8 preferably has a heating temperature of −15° C. to 5° C.

Furthermore, the methyl chlorosilane preparation device in the present example mainly includes: a third reactor 9, a fourth reactor 10, and a fifth reactor 11.

The third reactor 9 is connected with the scrubbing tower 8, and the second gas phase mixture is introduced into the third reactor 9, and is pressurized and heated to make the second gas phase mixture react and generate methanol, so as to yield a third gas phase mixture. In the present example, the third reactor 9 should have heating and pressurization functions, and the third reactor 9 may have a heating temperature of 220° C. to 250° C., and a pressure of 5.0 MPa to 6.0 MPa.

The fourth reactor 10 is connected with the third reactor 9. The third gas phase mixture is introduced into the fourth reactor 10 and hydrogen chloride is introduced into the fourth reactor 10, both of them are heated to make methanol react with hydrogen chloride to generate methane chloride, so as to yield a fourth gas phase mixture. In the present example, fourth reactor 10 may have a heating temperature of 130° C. to 150° C.

The fifth reactor 11 is connected with the fourth reactor 10. The fourth gas phase mixture is introduced into the fifth reactor 11, and silicon powder is introduced into the fifth reactor, both of them are heated to make methane chloride react with silicon powder to generate methyl chlorosilane, so as to yield a fifth gas phase mixture. Specifically, the fifth reactor 11 is a fluidized bed reactor, and may have a heating temperature of 280° C. to 320° C.

Specifically, the methyl chlorosilane preparation device in the present example further includes:

a third cooler 12, which is connected with the fifth reactor 11, and the third cooler 12 is used for cooling a fifth gas phase mixture output from the fifth reactor 11 into a liquid;

a third storage tank 13, which is connected with the third cooler 12, and the third storage tank 13 is used for storing the left liquid after cooling by the third cooler 12, and the liquid is methyl chlorosilane.

It should be noted that, the methyl chlorosilane preparation device in the present example further includes:

a hydrogen pipeline 14 connected with an inlet of the third reactor 9, and is used for introducing hydrogen gas into the third reactor 9, and the hydrogen pipeline 14 is provided with a first valve 16;

a hydrogen chloride pipeline 38 connected with an inlet 39 of the first reactor, and is used for introducing hydrogen chloride into the first reactor 1, and hydrogen chloride pipeline 38 is provided with a second valve 40;

a hydrocarbon detector 15, preferably arranged between the scrubbing tower 8 and the third reactor 9, which is used to detect the molar ratio of carbon to hydrogen in the gases introduced into the third reactor 9, and transmit the detected a molar ratio value of carbon to hydrogen;

a controller electrically connected to the hydrocarbon detector, and is used for receiving the molar ratio value of carbon to hydrogen in the gases that is introduced into the third reactor 9 detected by the hydrocarbon detector 15, and the controller is also electrically connected with the above-mentioned first valve and the above-mentioned second valve; the molar ratio value of carbon to hydrogen is preset in the controller, and the molar ratio value of carbon to hydrogen detected by the hydrocarbon detector is compared with preset value by the controller; when the molar ratio of carbon to hydrogen detected by the hydrocarbon detector is greater than a preset molar ratio of carbon to hydrogen, the controller open the first valve 16 to introduce hydrogen gas into the third reactor 9, until the detected molar ratio of carbon to hydrogen is equal to the preset molar ratio of carbon to hydrogen, and then the controller close the first valve 16; when the molar ratio of carbon to hydrogen detected by the hydrocarbon detector is less than the preset molar ratio of carbon to hydrogen, the controller close the second valve 40 to reduce the amount of hydrogen chloride introduced into the first reactor 1, until the detected molar ratio of carbon to hydrogen is equal to the preset molar ratio of carbon to hydrogen, and then the controller open the second valve 40.

Preferably, the combined system for preparing zirconium oxide and methyl chlorosilane in the present example further includes:

a stripping tower 17, a gas outlet of the stripping tower 17 is connected with an inlet of the fourth reactor 10,

the inlet of the stripping tower 17 is connected with the evaporator 4, and gas phase products evaporated by the evaporator 4 are introduced into the stripping tower 17 to strip hydrogen chloride, and the stripped hydrogen chloride is introduced into the fourth reactor 10 as a source of hydrogen chloride; and/or;

the inlet of stripping tower 17 is connected with the crystallizer 5, and gas phase products crystallized by the crystallizer 5 are introduced into the stripping tower 17 to strip hydrogen chloride, and the stripped hydrogen chloride is introduced into fourth reactor 10 as a source of hydrogen chloride.

It should be noted that, the combined system for preparing zirconium oxide and methyl chlorosilane in the present example further includes:

a stripping tower 17, a gas outlet of the stripping tower 17 is connected with the inlet of the fourth reactor 10,

the inlet of the stripping tower 17 is connected with the evaporator 4, and gas phase products evaporated by the evaporator 4 are introduced into the stripping tower 17 to strip hydrogen chloride, and the stripped hydrogen chloride is introduced into the fourth reactor 10 as a source of hydrogen chloride; and/or;

the inlet of stripping tower 17 is connected with the crystallizer 5, and gas phase products crystallized by the crystallizer 5 are introduced into the stripping tower 17 to strip hydrogen chloride, and the stripped hydrogen chloride is introduced into fourth reactor 10 as a source of hydrogen chloride; and

a liquid outlet of the stripping tower 17 is connected with an inlet of the hydrolysis tank 3, and waste liquid in the stripping tower 17 is supplemental flowed to the hydrolysis tank 3 as water for hydrolysis, which can reduce the used amount of water for hydrolysis in the hydrolysis tank 3.

It should be noted that, the methyl chlorosilane preparation device in the present example further includes:

a heat exchanger 18, which is connected with stripping tower 17 and also connected with evaporator 4, and the gas phase products produced by evaporating the hydrolysis mixture in the evaporator 4 are introduced into the heat exchanger 18 as a heat source, and the hydrolysis mixture is introduced into the heat exchanger 18 for raising temperature by heat exchange, and then the hydrolysis mixture after raising temperature by heat exchange is introduced into the evaporator 4 for evaporation, and then the gas phase products produced by evaporating the hydrolysis mixture in the in the evaporator 4 are introduced into the heat exchanger 18 for lowering temperature by heat exchange, after that the gas phase products are introduced into the stripping tower 17 for stripping.

Specifically, the heat exchanger 18 is used to recover the heat of the gas phase produced in the evaporator and to preheat the hydrolysis mixture output from the hydrolysis tank. The heat exchanger 18 includes a cold source inlet, a cold source outlet, a heat source inlet and a heat source outlet, wherein: the cold source inlet is connected with the outlet of the hydrolysis tank, and the cold source outlet is connected with the inlet of the evaporator, while the heat source inlet is connected with the gas outlet of the evaporator, and the outlet of the heat source is connected with the inlet of the stripping tower. The gas phase products produced by evaporating in the evaporator 4 are introduced into the heat exchanger as a heat source via the heat source inlet, and the hydrolysis mixture obtained from the hydrolysis tank 3 is introduced into the heat exchanger 18 via the cool source inlet for raising temperature by heat exchange with the above-mentioned heat source (i.e. phase products produced by evaporating in the evaporator 4), and then the hydrolysis mixture after raising temperature by heat exchange through the heat exchanger 18 is introduced into the evaporator 4 for evaporation, the gas phase products produced by evaporating in the evaporator 4 are introduced into the heat exchanger 18 for lowering the temperature by heat exchange with the above hydrolysis mixture introduced into the heat exchanger by the hydrolysis tank 3, then it becomes a gas-liquid mixture. The gas-liquid mixture is then introduced into the stripping tower 17 for stripping via the heat source inlet. In the present example, the heat exchanger 18 is a shell-and-tube heat exchanger 18, and the heat exchanger 18 is made of graphite.

Specifically, the methyl chlorosilane preparation device in the present example further includes:

a stripping tower kettle reboiler 19 connected with the stripping tower 17, and the stripping tower kettle reboiler 19 is used for heating the tower bottoms of the stripping tower 17. Specifically, an inlet of the stripping tower kettle reboiler 19 is connected with an outlet of the tower kettle of the stripping tower, and a gas outlet of the stripping tower kettle reboiler 19 is connected with an inlet of the stripping tower, so as to return gasification products to the stripping tower for stripping again. A liquid outlet of the stripping tower kettle reboiler 19 and/or the stripping tower is connected with the hydrolysis tank 3, and is used to allow waste liquid in the stripping tower kettle reboiler 19 and/or the stripping tower supplemental flowing to the hydrolysis tank 3, so as to use as water for hydrolysis, thereby the usage amount of water for hydrolysis in the hydrolysis tank 3 can be reduced.

It should be noted that the zirconium oxide preparation device in the present example further includes:

a second solid-liquid separator 20, an inlet of second solid-liquid separator 20 is connected with an outlet of hydrolysis tank 3, an outlet of the second solid-liquid separator 20 is connected with an inlet of evaporator 4, and the hydrolysis mixture through the hydrolysis tank 3 is introduced into the second solid-liquid separator 20 for performing solid-liquid separation to remove solid impurities, and then flows into the evaporator 4. Specifically, the second solid-liquid separator 20 in the present example is a filter press, and the filter press is made of FRPP (i.e., glass fiber reinforced polypropylene pipe).

Specifically, the zirconium oxide preparation device in the present example further includes:

a first cooler 21, which is arranged between the scrubbing tower 8 and the third reactor 9, an inlet of the first cooler 21 is connected with a gas outlet of the scrubbing tower 8, a gas outlet of the first cooler 21 is connected with an inlet of the third reactor 9, and the first cooler 21 is used for cooling the second gas phase mixture output from the scrubbing tower 8 to separate (or in other words, precipitate) the silicon tetrachloride liquid, so as to yield purified second gas phase products. In the present example, the first cooler 21 is a tubular heat exchanger.

In the present example, a liquid outlet of first cooler 21 is connected with the inlet of first cooling separator 2, and the silicon tetrachloride liquid separated from the second gas phase mixture is introduced into the first cooling separator 2 as a cold source to cool the first gas phase mixture, so as to separate the crude zirconium tetrachloride solid; and/or,

a liquid outlet of first cooler 21 is connected with an inlet of the scrubbing tower 8, and the silicon tetrachloride liquid separated by cooling the second gas phase mixture is introduced into the scrubbing tower 8 for scrubbing to remove or recover metal chloride impurities such as silicon tetrachloride in the second gas phase mixture.

Specifically, the combined system for preparing zirconium oxide and methyl chlorosilane in the present example further includes:

a first storage tank 22, the inlet of the first storage tank 22 is connected with the outlet of the first cooler 21, the first storage tank 22 is used to store the silicon tetrachloride liquid separated by the first cooler 21, a part of the silicon tetrachloride liquid in the first storage tank 22 flows into a first transfer pump 23, which can then be used as a cold source for the first cooler 2, and/or used as a scrubbing solution of the scrubbing tower 8, and the other part flows out for subsequent process, for example, polysilicon production process, that is to say, the first storage tank 22 can also be connected with a polycrystalline silicon preparation device, such as a hydrochlorination reactor.

a first transfer pump 23, an inlet of the first transfer pump 23 is connected with an outlet of the first storage tank 22, an outlet of the first transfer pump 23 is connected with an outlet of the scrubbing tower 8, and the first transfer pump 23 is used to transfer the silicon tetrachloride liquid in the first storage tank 22 to the scrubbing tower 8 as a scrubbing solution, and/or, an outlet of the first transfer pump 23 is connected with the first cooling separator 2, and the first transfer pump 23 is used to transfer the silicon tetrachloride liquid in the first storage tank 22 to the first cooling separator 2 of the scrubbing tower as a cooling source. In the present example, the first transfer pump 23 is a canned motor pump.

Specifically, the methyl chlorosilane preparation device in the present example further includes:

a compressor 24, an inlet of the compressor 24 is connected with a gas outlet of the first cooler 21, an outlet of the compressor 24 is connected with the third reactor 9, and the compressor 24 is used for compressing the purified second gas phase products.

It should be noted that the methyl chlorosilane preparation device in the present example further includes a second cooler 25 and a rectifying tower 26.

The second cooler 25 is connected with the third reactor 9, and is used to cool the third gas phase mixture output from the third reactor 9 so as to separate and yield crude methanol;

The rectifying tower 26 is arranged between the second cooler 25 and the fourth reactor 10, and is used for rectifying and purifying the crude methanol to yield purified third gas phase products. Specifically, an inlet and a gas outlet of the rectification tower 26 are connected with the second cooler 25 and the fourth reactor 10 respectively, and the crude methanol is rectified and purified in the rectification tower 26 to yield purified third gas phase products. In the present example, the purification process of the crude methanol in the rectifying tower can be carried out by a traditional process, which will not be repeated here.

In the present example, a gas outlet of the second cooler 25 is connected with an inlet of the compressor 24. After uncooled gases in the second cooler 25 are compressed by the compressor, they are continued to introduce into the third reactor 9 for reaction.

Specifically, the methyl chlorosilane preparation device in the present example further includes a second storage tank 27 and a second transfer pump 28.

The second storage tank 27 is arranged between the second cooler 25 and the rectification tower 26. Specifically, an inlet of the second storage tank 27 is connected with a liquid outlet of the second cooler 25, and an outlet of the second storage tank 27 is connected with an inlet of the rectifying tower 26. The second storage tank 27 is used to store crude methanol;

The second transfer pump 28 is arranged between the second storage tank 27 and the rectification tower. Specifically, an inlet of the second transfer pump 28 is connected with the second storage tank 27, and an outlet of the second transfer pump 28 is connected with the rectification tower 26. The second transfer pump 28 is used to transfer crude methanol to the rectification tower 26.

It should be noted that the methyl chlorosilane preparation device in the present example further includes:

a scrubbing and cooling tower 29 connected with the fourth reactor 10, wherein the fourth gas phase mixture enters the scrubbing and cooling tower 29 and uses water as a scrubbing solution for scrubbing and cooling to remove methanol and hydrogen chloride, in the present example, the water (i.e., the scrubbing solution) for scrubbing and cooling tower 29 is desalinated water;

a drying tower 30 arranged between the scrubbing and cooling tower 29 and the fifth reactor 11, wherein the drying tower 30 is used to dry and remove the by-product dimethyl ether during reaction of water, methanol and hydrogen chloride for generating methyl chlorosilane, so as to yield purified fourth gas phase products. Specifically, an inlet of the drying tower is connected with a gas outlet of the scrubbing and cooling tower, an outlet (gas outlet) of the drying tower 30 is connected with the fifth reactor 11, and the drying tower 30 is provided with a desiccant. In the present example, the desiccant is preferably concentrated sulfuric acid.

Specifically, the methyl chlorosilane preparation device in the present example further includes:

a heater 31, wherein an inlet of the heater 31 is connected with a gas outlet of the drying tower 30, an outlet of the heater 31 is connected with the inlet of the fifth reactor 11, and the heater 31 is used to heat the purified fourth gas phase products.

Specifically, the zirconium oxide preparation device in the present example further includes:

a beater 32, wherein an inlet of the beater 32 is connected with a solid phase outlet of the first solid-liquid separator 6, and the beater 32 is used to beat the solid separated by the first solid-liquid separator 6, so as to further release the liquid in the solid;

a centrifugal separator 33, wherein an inlet of the centrifugal separator 33 is connected with an outlet of the beater 32, an outlet of the centrifugal separator 33 is connected with an inlet of the second reactor 7, and the centrifugal separator 33 is used to separate solids (i.e., ZrOCl₂.8H₂O).

It should be noted that, in the present example, a liquid outlet of the first solid-liquid separator 6 is connected with an inlet of the hydrolysis tank 3, which is used to allow liquid separated in the first solid-liquid separator 6 flowing into the hydrolysis tank 3, so as to supplement water for hydrolysis, which can reduce the usage amount of water for hydrolysis in the hydrolysis tank 3.

It should be noted that the methyl chlorosilane preparation device in the present example further includes:

a cooling separator 34 on the top of the stripping tower, which is connected with the tower top of the stripping tower 17. The cooling separator 34 on the top of the stripping tower is used for cooling and separating water, and the cooled and separated water flows back into the stripping tower 17, and a gas outlet of the top reboiler of the stripping tower 17 is connected with the fourth reactor 10. Specifically, an inlet of the cooling separator on the top of the stripping tower is connected with a gas outlet of the stripping tower, a liquid outlet of the cooling separator on the top of the stripping tower is connected with an inlet of the tower top of the stripping tower, and a gas inlet of the cooling separator on the top of the stripping tower is connected with the fourth reactor; the cooling separator on the top of the stripping tower is used to cool the separate water, the cooled and separated water flows back into the stripping tower, and then hydrogen chloride from which the water has been removed flows into the fourth reactor.

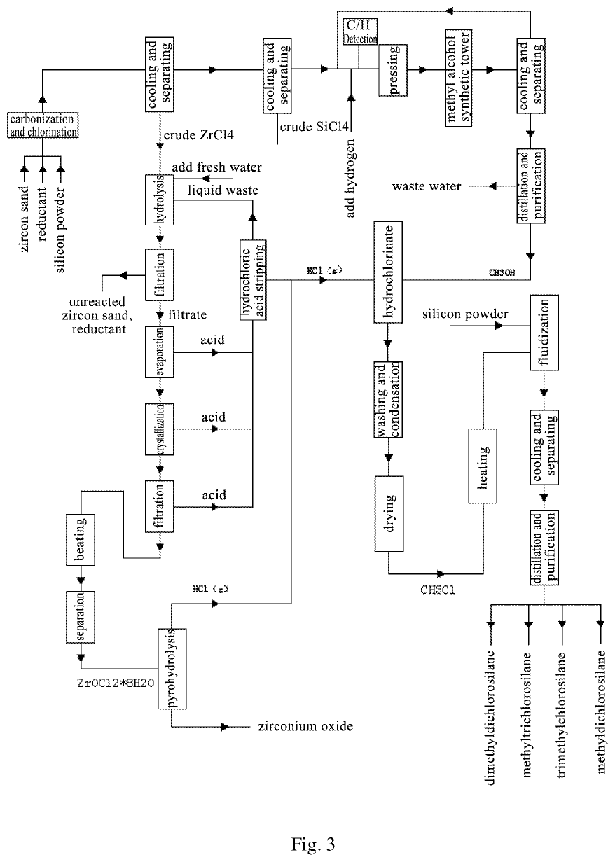

As shown in FIG. 3, an example of the present disclosure provides a combined process for preparing zirconium oxide and methyl chlorosilane using the above combined preparation system, and the combined process comprises the following steps:

(1) Preparation of a first gas phase mixture as an intermediate product: mixing and heating zircon sand, a reducing agent carbon, chlorine gas, a heat supplementing agent silicon and hydrogen chloride, wherein zircon sand, the reducing agent carbon and chlorine gas react to generate zirconium tetrachloride, silicon tetrachloride and carbon monoxide; the heat supplementing agent silicon, chlorine gas and hydrogen chloride react to generate silicon tetrachloride and hydrogen gas, so as to yield a first gas phase mixture;

wherein, the heating temperature is 1050° to 1200° C., in the present example the heating temperature is preferably 1050° C.; the molar ratio of zircon sand to heat supplementing agent silicon is 1:(1.2-1.6). In the present example, the molar ratio is preferably 1:1.6 and silicon powder is preferably used as heat supplementing agent silicon; the amount of reducing agent carbon should be kept in excess, preferably chlorine gas and hydrogen chloride can also be slightly excessive, and the specific amount can be selected according to the actual situation, which is not further defined in the present example.

Specifically, mixing zircon sand, the reducing agent carbon, chlorine gas, the heat supplementing agent silicon and hydrogen chloride in a first reactor, 1, and heating the mixture at a heating temperature of 1050° C., wherein zircon sand, the reducing agent carbon, and chlorine gas react to generate zirconium tetrachloride, silicon tetrachloride and carbon monoxide by carbonation and chlorination reaction, and the heat supplementing agent silicon, chlorine gas and hydrogen chloride react at high temperature to generate silicon tetrachloride and hydrogen gas, so as to yield the first gas phase mixture; the molar ratio of zircon sand to silicon powder is 1:1.6;

In the present example, the combined process further comprises removing hydrogen chloride and chlorine gas from the first gas phase mixture. In the present example, the dechlorinator 35 is used to remove hydrogen chloride and chlorine gas.

Specifically, hydrogen chloride and chlorine gas are removed by passing the first gas phase mixture through silicon powder in a dechlorinator 35.

(2) Preparation of zirconium oxide: cooling the first gas phase mixture from which hydrogen chloride and chlorine gas have been removed to separate a crude zirconium tetrachloride solid; hydrolyzing the crude zirconium tetrachloride solid to generate zirconium oxychloride, so as to yield a hydrolysis mixture; then subjecting the hydrolysis mixture to evaporation, crystallization and solid-liquid separation to yield zirconium oxychloride solid (the main component is ZrOCl₂.8H₂O); and then heating and calcining the zirconium oxychloride solid to produce zirconium oxide by decomposing;

wherein, water for hydrolyzing the zirconium tetrachloride solid includes supplemented fresh water, the supplemented fresh water is preferably desalinated water, and the mass ratio of zirconium tetrachloride to water for hydrolysis is 1:(3-4). In the present example, the mass ratio is preferably 1:3; and evaporating treatment temperature for zirconium tetrachloride and water is 85° C. to 100° C., preferably 85° C.; crystallization treatment temperature is 30° C. to 45° C., preferably 30° C.; the temperature at which the zirconium oxychloride solid is heated and calcined is 800° C. to 1000° C., and the preferred calcination temperature is 1000° C.; a belt filter, such as a vacuum belt filter, is used for solid-liquid separation.

Optionally, the water for hydrolysis in the present example also includes waste water produced in other stages of the combined preparation process in the present example, such as low-concentration acidic waste water produced in the hydrochloric acid stripping process in the stripping tower 17 and liquid phase products produced during evaporation, crystallization, and solid-liquid separation of the hydrolysis mixture.

In the present example, optionally, before subjecting the hydrolysis mixture to evaporation, crystallization, and solid-liquid separation to yield zirconium oxychloride solid, the combined process further comprises the following steps: subjecting the hydrolysis mixture to solid-liquid separation treatment to remove solid impurities. In the present example, subjecting the hydrolysis mixture to solid-liquid separation treatment refers to filtering the hydrolysis mixture in a filter press, and the solid impurities removed by filtration include unreacted zircon sand and a reducing agent.

Optionally, before heating and calcining the zirconium oxychloride solid, the combined process further comprises the following steps: beating the zirconium oxychloride solid to release liquid encapsulated in the zirconium oxychloride solid.

Specifically, the first gas phase mixture from which hydrogen chloride and chlorine gas have been removed is cooled and separated in the first cooling separator 2 to separate the crude zirconium tetrachloride solid, and the crude zirconium tetrachloride solid is introduced into the hydrolysis tank 3. Fresh water is supplemented to the hydrolysis tank 3, and the supplemented fresh water is desalinated water, and the water in the hydrolysis tank 3 includes: the low-concentration acidic waste water produced by the hydrochloric acid stripping process in the stripping tower 17 and the filtrate produced by filtering the zirconium oxychloride crystal slurry. The mass ratio of crude zirconium tetrachloride to water is 1:3. The crude zirconium tetrachloride is hydrolyzed in the hydrolysis tank 3 to generate zirconium oxychloride, so as to yield a hydrolysis mixture, and then the hydrolysis mixture is filtered in a filter press (i.e., the second solid-liquid separator 20), to remove solid impurities, wherein the solid impurities include unreacted zircon sand and a reducing agent;

Then, the hydrolysis mixture from which impurities have been removed is evaporated under a condition of 85° C. in the evaporator 4 to yield a concentrated solution with a ZrOCl₂ (zirconium oxychloride) concentration greater than 20 mas %, and the concentrated solution is crystallized in the crystallizer 5 under a condition of 30° C. to yield ZrOCl₂.8H₂O (zirconium oxychloride octahydrate) slurry, the crystallization slurry is filtered in a vacuum belt filter (i.e., the first solid-liquid separator 6) to yield a solid phase, which is a filter cake of ZrOCl₂.8H₂O. The liquid yielded by filtration is returned and introduced into the hydrolysis tank 3, and the solid-phase filter cake produced by the separation of the first solid-liquid separator 6 is introduced into the beater 32 for beating, and the filter cake is beat to release liquid encapsulated in the solids during crystallization, so as to yield slurry, and then the slurry is introduced into the centrifugal separator 33 for centrifugal separation to yield ZrOCl₂.8H₂O as a product, and the solid zirconium oxychloride is calcined in the second reactor 7 at a high temperature, and the second reactor 7 has a calcination temperature of 1000° C. ZrOCl₂.8H₂O is decomposed into zirconium oxide, hydrogen chloride gas and water vapor.

(3) Preparation of a second gas phase mixture as an intermediate product: scrubbing the first gas phase mixture from which the crude zirconium tetrachloride solid has been removed, cooling to separate and recovery silicon tetrachloride therein, so as to yield a second gas phase mixture comprising carbon monoxide and hydrogen gas. In the present example, silicon tetrachloride (liquid) is used as a scrubbing solution for scrubbing.

It should be noted that step (3) also includes further purifying the second gas phase mixture, and the specific steps are as follows: introducing the second gas phase mixture into the first cooler 21 to cool and separate the silicon tetrachloride liquid to yield purified second gas phase products, the separated silicon tetrachloride liquid is then introduced into the first storage tank 22 for temporary storage.

In the present example, a part of the silicon tetrachloride liquid in the first storage tank 22 can be used as a cold source (such as the cold source of the first cooler 2) and/or an scrubbing solution (such as the scrubbing solution of the scrubbing tower 8), and the other part can be used for subsequent processes, such as polycrystalline silicon preparation processes.

Specifically, scrubbing the first gas phase mixture separated from the crude zirconium tetrachloride solid in the first cooling separator 2 by using silicon tetrachloride as a scrubbing solution to recovery silicon tetrachloride therein, so as to yield a second gas phase mixture comprising carbon monoxide and hydrogen gas; introducing the second gas phase mixture into the first cooler 21 to cool and separate the silicon tetrachloride liquid, so as to yield purified second gas phase products, and the separated silicon tetrachloride liquid flows into the first storage tank 22, and transferring a part of the silicon tetrachloride liquid in the first storage tank 22 to the scrubbing tower 8 through the first transfer pump 23 for using as a scrubbing solution, and transferring the other part to the first cooler 2 through the first transfer pump 23 for using as a cold source to cool the first gas phase product, and the remainder flows out for subsequent processes.

(4) Preparation of intermediate product methanol: pressurizing and heating the second gas phase mixture to make reaction and generate methanol, so as to yield a third gas phase mixture, wherein, the pressurizing pressure is 5.0 MPa to 6.0 MPa, and the heating temperature is 220° C. to 250° C. In the present example, the pressurizing pressure is preferably 5.0 MPa, and the heating temperature is preferably 220° C.

Further, the molar ratio of carbon to hydrogen in the purified second gas phase products is 1:(4-5), preferably the molar ratio of carbon to hydrogen is 1:4. Therefore, before subjecting the above-mentioned purified second gas phase products to pressurize and heat to react to generate methanol, detecting and adjusting the molar ratio of carbon to hydrogen to achieve the desired range of the molar ratio of carbon to hydrogen.

Specifically, the purified second gas phase mixture is compressed by the compressor 24, and then introduced into the third reactor 9, and the hydrocarbon detector 15 is used to detect the molar ratio of carbon to hydrogen in the gases introduced into the third reactor 9; the preset molar ratio of carbon to hydrogen is 1:4; when the detected molar ratio of carbon to hydrogen is greater than a preset molar ratio, the first valve 16 on the hydrogen pipeline 14 is opened by the controller to introduce hydrogen gas into the third reactor 9, until the molar ratio of carbon to hydrogen is equal to the preset molar ratio of carbon to hydrogen, then the first valve 16 is closed by the controller; when the detected molar ratio of carbon to hydrogen is less than the preset molar ratio of carbon to hydrogen, the second valve 40 is closed by the controller to reduce amount of hydrogen chloride introduced into the first reactor 1, until the molar ratio of carbon to hydrogen is equal to the preset molar ratio of carbon to hydrogen, the second valve 40 is opened by the controller;

the third reactor 9 has a pressurizing pressure of 5.0 MPa, and a heating temperature of 220° C. The reaction is carried out to produce methanol, so as to yield a third phase mixture.

In the present example, it also includes purifying the third gas phase mixture, which specifically includes the following steps:

introducing the third gas phase mixture produced by the reaction in the third reactor 9 into the second cooler 25 to cool and separate, so as to yield crude methanol (i.e., the liquid phase product produced by cooling) and gas phase products that is not cooled to liquid phase products. The uncooled liquid products can be returned to be mixed with the above-mentioned purified second gas phase products, and then enter the third reactor 9 to react to generate methanol. The crude methanol flows into the second storage tank 27, and then transfers to the rectification tower 26 through the second transfer pump 28, and the crude methanol is rectified and purified by the rectification tower 26. The sewage is discharged from the rectification tower 26 to yield purified third gas phase products, and the main component of the third gas phase products is methanol

It should be noted that, in the present example, the process conditions for purifying crude methanol in the rectifying tower can adopt the existing traditional process conditions, which will not be repeated here.

(5) Preparation of the intermediate product methane chloride: mixing and heating the third gas phase mixture with hydrogen chloride to react to generate methane chloride and dimethyl ether, so as to yield a fourth gas phase mixture;

wherein, the heating temperature of the third gas phase mixture and hydrogen chloride is 130 to 150° C., preferably 130° C.

In the present example, the combined process further comprises a step of adding a catalyst, and the catalyst is preferably zinc chloride.

Specifically, introducing the third gas phase mixture into the fourth reactor 10, and introducing hydrogen chloride into the fourth reactor 10, and heating in the fourth reactor 10, the heating temperature is 130° C., and the catalyst used for the reaction is zinc chloride, and a hydrochlorination reaction occurs to generate methane chloride and dimethyl ether, so as to yield a fourth gas phase mixture.

In the present example, hydrogen chloride introduced into the fourth reactor 10 in step (4) may be additionally introduced hydrogen chloride, or hydrogen chloride extracted from the gas phase products separated during preparing zirconium oxide, namely, one or more of the gas phase products produced by evaporation of the hydrolysis mixture in the evaporator 4 and crystallization of the hydrolysis mixture in the crystallizer 5 are introduced into the stripping tower 17 to strip hydrogen chloride, and the stripped hydrogen chloride is purified, and then passed into the fourth reactor 10 as a source of the required hydrogen chloride.

In the present example, the stripping tower 17 has a stripping temperature of 40° C. to 60° C., and a pressure of 0.1 MPa to 0.3 MPa. In the present example, the stripping tower 17 preferably has a stripping temperature of 40° C., and a pressure of 0.3 MPa.

In some optional embodiments, the stripping tower 17 has a tower top temperature of 40° C. to 60° C. and a tower kettle temperature of 100° C. to 120° C., and a pressure of 20 KPa to 40 KPa.

Specifically, introducing the gas phase products produced by evaporation of the hydrolysis mixture in the evaporator 4 and crystallization of the hydrolysis mixture in the crystallizer 5 into the stripping tower 17 to stripe hydrogen chloride, and the stripping tower 17 has a stripping temperature of 40° C., and a pressure of 0.3 MPa; introducing hydrogen chloride discharged from the gas phase outlet of the stripping tower 17 into the cooling separator 34 on the top of the stripping tower to cool and separate water therein, so as to yield hydrogen chloride gas with a purity greater than 99.9 mas % and a moisture content of less than 1000 ppm; allowing water after cooled and separated to flow back into the stripping tower 17, and discharging the waste liquid (mainly low-concentration waste acid) produced after stripping into the hydrolysis tank 3 as water for hydrolysis; then introducing hydrogen chloride from which water has been removed into the fourth reactor 10 as a source of hydrogen chloride; the combined preparation process according to the present example can effectively utilize the acid waste gas and waste liquid generated during preparing zirconium oxide at a high value, avoid environmental pollution, reduce the treatment cost of waste acid and waste gas, while reduce production cost of methyl chlorosilane.

It should be noted that, in the present example, introducing gas phase products produced by evaporation of the hydrolysis mixture in the evaporator 4 into the heat exchanger 18 as a heat source: introducing the hydrolysis mixture in the hydrolysis tank 3 into the heat exchanger 18 for raising temperature by heat exchange, and then the hydrolysis mixture after raising temperature by heat exchange is introduced into the evaporator 4 for evaporation, and then the gas phase products produced by evaporating the hydrolysis mixture in the in the evaporator 4 are introduced into the heat exchanger 18 for lowering temperature by heat exchange, after that the gas phase products are introduced into the stripping tower 17 for stripping; heating the tower bottoms of the stripping tower 17 by the stripping tower kettle reboiler 19, and making the waste liquid in the stripping tower 17 to supplemental flow to the hydrolysis tank 3.

(6) Preparation of methyl chlorosilane: heating the fourth gas phase mixture, and adding silicon powder, making methane chloride in the fourth gas phase mixture to react with the silicon powder to generate methyl chlorosilane, so as to yield a fifth gas phase mixture, wherein, the heating temperature (that is, the reaction temperature in the fifth reactor) for the fourth gas phase mixture is 280° C. to 320° C., preferably 280° C. In the present example, a catalyst is added during the reaction of methane chloride and silicon powder, and the catalyst can be copper or copper salt, preferably copper.

It should be noted that, in the present example, before subjecting the fourth gas phase mixture to react with silicon powder to generate methyl chlorosilane, scrubbing, washing and drying the fourth gas phase mixture to yield purified fourth gas phase products, Specifically, the combined process include the following steps:

introducing the fourth gas phase mixture into the scrubbing and cooling tower 29, scrubbing and cooling the fourth gas phase mixture by using water as a scrubbing solution to remove methanol and hydrogen chloride in the fourth gas phase mixture, and then introducing into drying tower 30 for drying to remove water and dimethyl ether, so as to yield purified fourth gas phase products. In the present example, the purity of methyl chlorosilane in the purified fourth gas phase products is greater than 99 mas %.

Specifically, heating the above-mentioned purified fourth gas phase mixture (that is, the purified fourth gas phase products) by the heater 31, and then introducing the fourth gas phase mixture into a fifth reactor 11 at a heating temperature of 280° C.; introducing silicon powder into the fifth reactor 11, heating to make methane chloride react with the silicon powder under a condition of copper or copper salt used as a catalyst to generate methyl chlorosilane, so as to yield a fifth gas phase mixture; the reaction process is exothermic, and heat released by the reaction process in the fifth reactor 11 is removed by cooling water to ensure that the fifth reactor 11 has a temperature of 280° C.; introducing the fifth gas phase mixture into the third cooler 12 to cool and obtain liquid, then introducing the obtained liquid into the third storage tank 13 to store the cooled liquid, said liquid is methyl chlorosilane. By rectifying and purifying methyl chlorosilane, dimethyl dichlorosilane, methyl trichlorosilane, trimethyl chlorosilane and methyl dichlorosilane are obtained.

In some optional embodiments, zircon sand in the present example is ZrSiO₄, and the molar ratio of the raw materials used is ZrSiO₄:C:Cl₂:Si:HCl=1:(4-5):4:(3-4):(12˜16), the mass ratio is ZrSiO₄:C:Cl₂:Si:HCl=183:(48˜60):283:(84˜112):(439-583); after zircon sand is subjected to carbonization and chlorination reaction, it is passed through silicon powder in a dechlorinator 35 to remove hydrogen chloride and chlorine gas, and the resulting product (that is, the first gas phase mixture) has a composition of: ZrCl=(186-233) kg, CO=(89˜112) kg, SiCl₄=(815˜849) kg, H₂=(12˜16) kg; SiCl₄ (zirconium tetrachloride) is hydrolyzed and calcined to produce zirconium oxide product (98˜123) kg; after the first gas phase mixture is scrubbing and cooling a second gas phase mixture is produced; after the second gas phase mixture is subjected to cooling, methanolization reaction, cooling and rectification, 81-128 kg of methanol is produced (that is, the purified third gas phase products); the purified third gas phase products are subjected to hydrochlorination reaction, stripping and drying to produce 109-201 kg of methyl chlorosilane (that is, the purified fourth gas phase products); the purified third gas phase products are subjected to hydrochlorination reaction, scrubbing and drying to produce 109-201 kg of methyl chlorosilane (that is, the purified fourth gas phase products); after methyl chlorosilane and silicon powder are subjected to fluidization reaction, cooling and separation, methyl chlorosilane product is produced; after the methyl chlorosilane product is subjected to rectification and purification treatment 98-361 kg of dimethyl dichlorosilane can be produced.

The combined process for preparing zirconium oxide and methyl chlorosilane and the combined system in the present examples can realize the recycling of chlorine, carbon and hydrogen elements, reduce the production cost of methane chloride by 50-65%, and reduce the production cost of methyl chlorosilane (mainly refers to dimethyl dichlorosilane) by 20-35%; at the same time, it can reduce the treatment cost of waste water and waste gas during preparing zirconium oxide, in turn, further reduce the comprehensive preparation cost of zirconium oxide by 10% to 15%, and finally avoid greenhouse gas emissions. Specifically, it can be reflected in the following aspects:

TABLE 1
Cost analysis of methanol production
from natural gas (yuan/ton)

| | |
|---|---|
| Raw material gases | 1050 |
| Electric power | 32 |
| Auxiliary material | 72.5 |
| Labor cost | 4 |
| Depreciation and | 212.6 |
| management fees | |

In step (4), carbon monoxide and hydrogen gas in the tail gases during preparing zirconium oxide in steps (1) to (3) are turned into valuable materials, which not only makes the exhaust gases during preparing zirconium oxide need not be treated, but also makes the exhaust gases such as carbon monoxide and hydrogen gas are directly used as raw materials for preparing methanol. In the process of preparing methanol, the raw materials carbon monoxide and hydrogen gas account for 80% of the cost (as shown in Table 1), so that it can greatly reduce the production cost of methanol, thereby reduce the production cost of preparing methyl chlorosilane in the subsequent steps (5) and (6).

In addition, in step (2), the waste water and waste gas containing hydrogen chloride are directly used as raw materials for preparing methyl chlorosilane in the subsequent step (5) through the stripping of the stripping tower 17, so that the waste water and waste gas containing hydrogen chloride are turned into valuable materials, which not only avoids the treatment cost of waste water and waste gas, but also reduces the production cost of methyl chlorosilane, thereby reduce the production cost of preparing methyl chlorosilane in the subsequent step (6).

In the example of the present disclosure, carbon monoxide and hydrogen chloride generated during preparing zirconium oxide are used as raw materials for preparing methyl chlorosilane, so that both waste gases and silicon tetrachloride can be effectively recycled with high value, which reduces the treatment cost of waste gases and silicon tetrachloride, avoids environmental pollution, reduces the production cost of methyl chlorosilane and polycrystalline silicon, and improves the technological level as well as the comprehensive economic benefits.

### Example 3

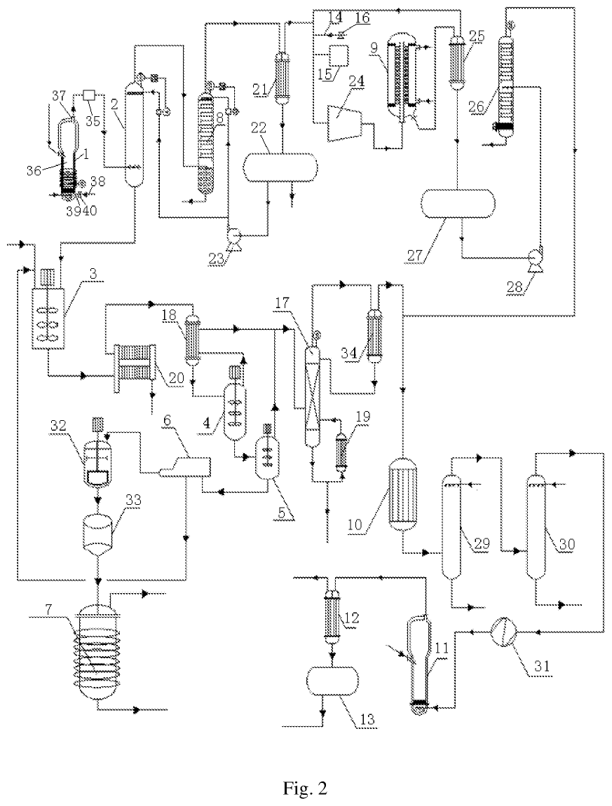

As shown in FIG. 2, the example of the present disclosure provides a combined system for preparing zirconium oxide and methyl chlorosilane, and the difference from the combined system in Example 2 is that: the dechlorinator 35 is arranged between the first reactor 1 and the first cooling separator 2, an inlet of the dechlorinator 35 is connected with an outlet of the first reactor 1, and an outlet of the dechlorinator 35 is connected with the first cooling separator 2.

The example of the present disclosure also provide a combined process for preparing zirconium oxide and methyl chlorosilane using the above combined system, and the difference from the combined process in example 2 is that:

in step (1), first reactor 1 has a heating temperature of 1200° C., and the molar ratio of zircon sand to silicon powder is 1:1.3;

in step (2), the mass ratio of crude zirconium tetrachloride to water is 1:4, the evaporator 5 has a temperature of 100° C., the crystallizer has a temperature of 40° C., and the second reactor 7 has a high-temperature calcination temperature of 800° C.; in step (4), the preset molar ratio of carbon to hydrogen is 1:5, the third reactor 9 has a pressurization pressure of 6.0 MPa, and a heating temperature of 250° C.;

in step (5), the fourth reactor 10 has a heating temperature of 140° C.; the stripping tower 17 has a stripping temperature of 50° C., and a pressure of 0.1 MPa;

in step (6), the fifth reactor 11 has a heating temperature of 320° C.

### Example 4

The example of the present disclosure provides a combined process for preparing zirconium oxide and methyl chlorosilane using the combined system in Example 2, and the difference from the process in Example 2 is that:

in step (1), the first reactor 1 has a heating temperature of 1100° C., and the molar ratio of zircon sand to silicon powder is 1:1.4;

in step (2), the mass ratio of crude zirconium tetrachloride to water is 1:3.5, the evaporator 5 has a temperature of 95° C., the crystallizer has a temperature of 45° C., and the second reactor 7 has a high-temperature calcination temperature of 900° C.;

in step (4), the preset molar ratio of carbon to hydrogen is 1:4.5, the third reactor 9 has a pressurization pressure of 5.5 MPa, and a heating temperature of 235° C.;

in step (5), the fourth reactor 10 has a heating temperature of 150° C.; the stripping tower 17 has a stripping temperature of 60° C., and a pressure of 0.2 MPa;

in step (6), the fifth reactor 11 has a heating temperature of 300° C.

### Example 5

An example of the present disclosure provides a combined system for preparing zirconium oxide, methyl chlorosilane and polycrystalline silicon, wherein the system includes the combined system for preparing zirconium oxide and methyl chlorosilane according to Example 1, and further includes:

a polycrystalline silicon preparation device which is connected with the zirconium oxide preparation device and is used for preparing polycrystalline silicon by using the silicon tetrachloride separated by the zirconium oxide preparation device as a raw material.

The example of the present disclosure also provide a combined process for preparing zirconium oxide, methyl chlorosilane, and polycrystalline silicon using the above-mentioned combined system for preparing zirconium oxide, methyl chlorosilane, and polycrystalline silicon, comprising:

adopting the liquid phase products separated during the combined process for preparing zirconium oxide and methyl chlorosilane according to Example 1, said liquid phase products comprise silicon tetrachloride, and said silicon tetrachloride is used as a raw material to prepare polycrystalline silicon. Specifically, the steps are as follows

using the silicon tetrachloride liquid phase products separated during the combined process as a raw material to prepare polycrystalline silicon, which comprises firstly performing a hydrochlorination with silicon tetrachloride to produce trichlorosilane, and then performing a hydrogen reduction reaction with the trichlorosilane to produce polycrystalline silicon.

In the example of the present disclosure, not only carbon monoxide and hydrogen chloride generated during preparing zirconium oxide are used as raw materials for preparing methyl chlorosilane, but also silicon tetrachloride, a by-product generated during preparing zirconium oxide, is used as a raw material for preparing polycrystalline silicon, so that both waste gases and silicon tetrachloride can be effectively recycled with high value, which reduces the treatment cost of waste gases and the by-product silicon tetrachloride, avoids environmental pollution, reduces the production cost of methyl chlorosilane and polycrystalline silicon, and improves the technological level as well as the comprehensive economic benefits.

### Example 6

An example of the present disclosure provides a combined system for preparing zirconium oxide, methyl chlorosilane and polycrystalline silicon used in a combined process for preparing zirconium oxide, methyl chlorosilane and polycrystalline silicon, the system includes the combined system for preparing zirconium oxide and methyl chlorosilane according to the Example 2 or Example 3, and the zirconium oxide preparation device of the present example is also used to separate silicon tetrachloride during preparing zirconium oxide.

As shown in FIG. 1 or FIG. 2, the combined system for preparing zirconium oxide, methyl chlorosilane and polycrystalline silicon in the present example further includes:

a polycrystalline silicon preparation device (not shown in the figure) which is connected with the zirconium oxide preparation device and is used for preparing polycrystalline silicon by using the silicon tetrachloride separated by the zirconium oxide preparation device as a raw material.

Furthermore, the polycrystalline silicon preparation device includes a hydrochlorination reactor, a rectification and purification unit, and a CVD reduction furnace (CVD, that is, chemical vapor deposition).

The hydrochlorination reactor, preferably a fluidized bed reactor, is connected with the zirconium oxide preparation device, such as connected with the first storage tank 20, and is used for making the by-product silicon tetrachloride produced by the zirconium oxide preparation device with silicon powder, hydrogen gas, hydrogen chloride undergoing a hydrochlorination reaction to generate trichlorosilane.

The rectification and purification unit includes a plate rectification tower and a packed rectification tower, wherein the plate rectification tower is connected with a hydrochlorination reactor, and is used to remove silicon tetrachloride in the mixture solution of trichlorosilane and silicon tetrachloride generated in the hydrochlorination reactor, and high-boiling metal impurities, wherein the high-boiling point metal impurities include aluminum chloride, ferric chloride, calcium chloride, etc.; the packing rectification tower is connected with the plate rectification tower, which is used to purify trichlorosilane liquid from which silicon tetrachloride and high-boiling point metal impurities have been removed in the plate rectification tower, so as to further remove dichlorodihydrosilicon and the metal impurities such as phosphorus chloride and boron chloride in the trichlorosilane liquid to produce purified trichlorosilane.

The CVD reduction furnace is connected with the packing rectification tower, and is used for performing chemical vapor deposition reaction on purified trichlorosilane with hydrogen gas under a condition of heating to reduce trichlorosilane to polycrystalline silicon. CVD furnace may have a heating temperature of 1000° C. to 1100° C., and in the present example, CVD furnace preferably have a heating temperature of 1080° C.

It should be noted that, in the present example, the polycrystalline silicon preparation device may also use a traditional process method, such as a Siemens process or a modified Siemens process device, and the similarities will not be repeated one by one.

The example of the present disclosure also provide a combined process for preparing zirconium oxide, methyl chlorosilane, and polycrystalline silicon using the above-mentioned combined system for preparing zirconium oxide, methyl chlorosilane, and polycrystalline silicon, in addition to comprise steps (1) to (6) according to Example 3, the process further comprises step (7):

(7) Preparing polycrystalline silicon: using the silicon tetrachloride liquid phase products separated during preparing zirconium oxide as a raw material to prepare polycrystalline silicon, which comprises firstly performing a hydrochlorination with said silicon tetrachloride to produce trichlorosilane, and then performing a hydrogen reduction reaction with the trichlorosilane to produce polycrystalline silicon.

Specifically, using the silicon tetrachloride separated in step (3) as a raw material, and introducing into the polycrystalline silicon preparation device to prepare polycrystalline silicon, that is, firstly, introducing silicon tetrachloride into the hydrochlorination reactor as a raw material, and then adding silicon powder, hydrogen gas, hydrogen chloride and other raw materials, making the above raw materials undergo hydrochlorination reaction to produce trichlorosilane; then introducing the silicon trichloride into the plate purification tower and the packed rectification tower successively for purification to produce purified trichlorosilane; after that, introducing the purified trichlorosilane into the CVD reduction furnace, and feeding hydrogen gas, so that the trichlorosilane and the hydrogen undergo a reduction reaction to yield polycrystalline silicon.

It should be noted that, in the present example, the process for preparing polycrystalline silicon is preferably performed by using Siemens method or modified Siemens method, and the specific process parameters and the same steps will not be repeated here.

In the example of the present disclosure, not only carbon monoxide and hydrogen chloride generated during preparing zirconium oxide are used as raw materials for preparing methyl chlorosilane, but also silicon tetrachloride, a by-product generated during preparing zirconium oxide, is used as a raw material for preparing polycrystalline silicon, so that both waste gases and the by-product silicon tetrachloride can be effectively recycled with high value, which reduces the treatment cost of waste gases and silicon tetrachloride, avoids environmental pollution, reduces the production cost of methyl chlorosilane and polycrystalline silicon, and improves the technological level as well as the comprehensive economic benefits.

### Example 7

An Example of the present disclosure provides a combined system for preparing zirconium oxide and polycrystalline silicon, the system includes:

a zirconium oxide preparation device, which is used to prepare zirconium oxide with zircon sand, a reducing agent carbon, chlorine gas, a heat supplementing agent silicon and hydrogen chloride as raw materials, and the zirconium oxide preparation device is also used to separate gas phase products of carbon monoxide, hydrogen gas and hydrogen chloride produced during preparing zirconium oxide;

a polycrystalline silicon preparation device, which is connected with said zirconium oxide preparation device and is used for preparing polycrystalline silicon by using the silicon tetrachloride separated by said zirconium oxide preparation device as a raw material.

It should be noted that the zirconium oxide preparation device in the present example adopts the same device as the zirconium oxide preparation device in Example 6, and the details are not repeated here. The waste gases such as carbon monoxide and hydrogen chloride separated from the zirconium oxide preparation device can be used for subsequent processes, such as the preparation of methyl chlorosilane.

It should be noted that, the polycrystalline silicon preparation device in the present example adopts the same device as the polycrystalline silicon preparation device in example 6, and the details are not repeated here.

The example of the present disclosure also provide a combined process for preparing zirconium oxide and polycrystalline silicon using the above-mentioned combined system for preparing zirconium oxide and polycrystalline silicon, the process comprises:

preparing zirconium oxide by using zircon sand, a reducing agent carbon, chlorine gas, a heat supplementing agent silicon and hydrogen chloride as raw materials, wherein liquid phase products separated during preparing zirconium oxide include silicon tetrachloride; and

preparing polycrystalline silicon by using the separated liquid phase products during preparing zirconium oxide as the raw materials.

It should be noted that the processes for preparing zirconium oxide and polycrystalline silicon in the present example are the same as those processes in Example 6, which will not be repeated here.

In the example of the present disclosure, silicon tetrachloride, a by-product generated during preparing zirconium oxide, is used as a raw material for preparing polycrystalline silicon, so that the by-product silicon tetrachloride can be effectively recycled with high value, which reduces the treatment cost of the by-product, and further reduces the production cost of polycrystalline silicon, and improves the technological level as well as the comprehensive economic benefits.

It can be understood that the above embodiments are merely exemplary implementations used to illustrate the principle of the present invention, but the present invention is not limited thereto. For those skilled in the art, various variations and modifications can be made without departing from the spirit and essence of the present invention, and these variations and modifications are also within the protection scope of the present invention.

What is claimed is:

1. A combined process for preparing zirconium oxide and methyl chlorosilane, comprising:
preparing zirconium oxide by using zircon sand, carbon as a reducing agent, chlorine gas, silicon as a heat supplementing agent and hydrogen chloride as raw materials, wherein products separated during preparing zirconium oxide include gas phase products and liquid phase products, and said gas phase products include carbon monoxide, hydrogen gas and hydrogen chloride; and
preparing methyl chlorosilane by using the separated gas phase products during preparing zirconium oxide as raw materials.

2. The combined process for preparing zirconium oxide and methyl chlorosilane according to claim 1, wherein the combined process specifically comprises the following steps:
mixing and heating zircon sand, the reducing agent carbon, chlorine gas, the heat supplementing agent silicon and hydrogen chloride in a first reactor, wherein zircon sand, the reducing agent carbon and chlorine gas react to generate zirconium tetrachloride, silicon tetrachloride and carbon monoxide; the heat supplementing agent silicon, chlorine gas and hydrogen chloride react to generate silicon tetrachloride and hydrogen gas, so as to yield a first gas phase mixture;
removing hydrogen chloride and chlorine gas from the first gas phase mixture by passing the first gas phase mixture through silicon powder in a dechlorinator;
cooling the first gas phase mixture from which hydrogen chloride and chlorine gas have been removed to separate a crude zirconium tetrachloride solid; hydrolyzing the crude zirconium tetrachloride solid to generate zirconium oxychloride, so as to yield a hydrolysis mixture; then subjecting the hydrolysis mixture to evaporation, crystallization and solid-liquid separation to yield solid zirconium oxychloride; and heating the solid zirconium oxychloride in a second reactor to yield zirconium oxide;
scrubbing the first gas phase mixture from which the crude zirconium tetrachloride solid has been removed by using silicon tetrachloride as a scrubbing solution to recovery silicon tetrachloride therein, so as to yield a second gas phase mixture comprising carbon monoxide and hydrogen gas;
introducing the second gas phase mixture into a third reactor; pressurizing and heating to make reaction and generate methanol, so as to yield a third gas phase mixture;
introducing the third gas phase mixture into a fourth reactor, and introducing hydrogen chloride into the fourth reactor, heating to make methanol react with hydrogen chloride to generate methane chloride, so as to yield a fourth gas phase mixture;
introducing the fourth gas phase mixture into a fifth reactor, and introducing silicon powder into the fifth reactor, heating to make methane chloride react with the silicon powder to generate methyl chlorosilane, so as to yield a fifth gas phase mixture.

3. The combined process for preparing zirconium oxide and methyl chlorosilane according to claim 2, wherein the combined process further comprises the following steps:
detecting a molar ratio of carbon to hydrogen in the gases introduced into the third reactor by a hydrocarbon detector, when a detected molar ratio of carbon to hydrogen is greater than a preset molar ratio of carbon to hydrogen, hydrogen gas is introduced into the third reactor, until the molar ratio of carbon to hydrogen in the gases introduced into the third reactor is equal to the preset molar ratio of carbon to hydrogen; when the detected molar ratio of carbon to hydrogen is less than the preset molar ratio of carbon to hydrogen, amount of hydrogen chloride introduced into a first reactor is reduced, until the molar ratio of carbon to hydrogen in the gases introduced into the third reactor is equal to the preset molar ratio of carbon to hydrogen.

4. The combined process for preparing zirconium oxide and methyl chlorosilane according to claim 3, wherein the preset molar ratio of carbon to hydrogen is 1:4 to 1:5.

5. The combined process for preparing zirconium oxide and methyl chlorosilane according to any one of claims 2 to 4, wherein the third reactor has a pressure of 5.0 MPa to 6.0 MPa, and a heating temperature of 220° C. to 250° C.

6. The combined process for preparing zirconium oxide and methyl chlorosilane according to any one of claims 2 to 4, wherein the combined process further comprises the following steps:
introducing one or more of the gas phase products produced by evaporation of the hydrolysis mixture and crystallization of the hydrolysis mixture into a stripping tower to stripe hydrogen chloride, and then the hydrogen chloride stripped is used as a source of hydrogen chloride for introducing into the fourth reactor.

7. The combined process for preparing zirconium oxide and methyl chlorosilane according to claim 6, wherein said stripping tower has a stripping temperature of 40° C. to 60° C., and a pressure of 0.1 MPa to 0.3 MPa.

8. The combined process for preparing zirconium oxide and methyl chlorosilane according to claim 6, wherein the combined process further comprises the following steps:
introducing gas phase products produced by evaporation of the hydrolysis mixture into a heat exchanger as a heat source: introducing the hydrolysis mixture into the heat exchanger for raising temperature by heat exchange, then evaporating the hydrolysis mixture after raising temperature by heat exchange; introducing the gas phase products produced by evaporating the hydrolysis mixture into the heat exchanger for lowering temperature by heat exchange, after that introducing the gas phase products into the stripping tower for stripping.

9. The combined process for preparing zirconium oxide and methyl chlorosilane according to claim 6, wherein the combined process further comprises the following steps:
cooling hydrogen chloride discharged from a gas phase outlet of the stripping tower to separate water therein, and introducing hydrogen chloride from which water has been removed into the fourth reactor.

10. The combined process for preparing zirconium oxide and methyl chlorosilane according to any one of claims 2 to 4, 7, 8, and 9, wherein, before subjecting the hydrolysis mixture to evaporation, crystallization, and solid-liquid separation to yield solid zirconium oxychloride, the combined process further comprises the following steps:
subjecting the hydrolysis mixture to solid-liquid separation to remove solid impurities therein.

11. The combined process for preparing zirconium oxide and methyl chlorosilane according to any one of claims 2 to 4, 7, 8, and 9, wherein, before introducing the second gas phase mixture into the third reactor, the combined process further comprises the following steps:
cooling the second gas phase mixture to separate silicon tetrachloride liquid, so as to yield purified second gas phase products.

12. The combined process for preparing zirconium oxide and methyl chlorosilane according to claim 11, wherein the combined process further comprises the following steps:
using the silicon tetrachloride liquid separated by cooling the second gas phase mixture as a cold source for the step of cooling to separate the crude zirconium tetrachloride solid from the first gas phase mixture; and/or,
using the silicon tetrachloride liquid separated by cooling the second gas phase mixture as a scrubbing solution for the step of scrubbing the first gas phase mixture, from which silicon tetrachloride has been separated, so as to remove silicon tetrachloride therein.

13. The combined process for preparing zirconium oxide and methyl chlorosilane according to any one of claims 2 to 4, 7, 8, 9, and 12, wherein, before introducing the third gas phase mixture into the fourth reactor, the combined process further comprises the following steps:
cooling the third gas phase mixture to yield crude methanol, and purifying the crude methanol by rectification to yield purified third gas phase products.

14. The combined process for preparing zirconium oxide and methyl chlorosilane according to any one of claims 2 to 4, 7, 8, 9, and 12, wherein, before introducing the fourth gas phase mixture into the fifth reactor, the combined process further comprises the following steps:
scrubbing and cooling the fourth gas phase mixture by using water as a scrubbing solution to remove methanol and hydrogen chloride, and then drying to remove water, so as to yield purified fourth gas phase products.

15. The combined process for preparing zirconium oxide and methyl chlorosilane according to any one of claims 2 to 4, 7, 8, 9, and 12, wherein the first reactor has a heating temperature of 1050° C. to 1200° C., and/or the second reactor has a heating temperature of 800° C. to 1000° C.

16. The combined process for preparing zirconium oxide and methyl chlorosilane according to any one of claims 2 to 4, 7, 8, 9, and 12, wherein the fourth reactor has a heating temperature of 130° C. to 150° C.

17. The combined process for preparing zirconium oxide and methyl chlorosilane according to any one of claims 2 to 4, 7, 8, 9, and 12, wherein the fifth reactor has a heating temperature of 280° C. to 320° C.

18. The combined process for preparing zirconium oxide and methyl chlorosilane according to any one of claims 2 to 4, 7, 8, 9, and 12, wherein, the combined process further comprises the following steps:
returning liquid produced by evaporation, crystallization and solid-liquid separation of the hydrolysis mixture to the hydrolysis mixture which is produced by hydrolyzing the crude zirconium tetrachloride solid to generate zirconium oxychloride, and then subjecting the hydrolysis mixture to evaporation, crystallization and solid-liquid separation.

19. A combined process for preparing zirconium oxide, methyl chlorosilane and polycrystalline silicon, wherein said liquid phase products separated during the combined process for preparing zirconium oxide and methyl chlorosilane according to claim 1 comprises silicon tetrachloride, and said silicon tetrachloride is used as a raw material to prepare polycrystalline silicon.

20. The combined process for preparing zirconium oxide, methyl chlorosilane and polycrystalline silicon according to claim 19, wherein, the combined process for preparing zirconium oxide and methyl chlorosilane according to any one of claims 2 to 4, 7, 8, 9, and 12 further comprises the following steps:
using said silicon tetrachloride liquid phase products separated during preparing zirconium oxide as a raw material to prepare polycrystalline silicon, which comprises firstly performing a hydrochlorination with said silicon tetrachloride to yield trichlorosilane, and then performing a hydrogen reduction reaction with the trichlorosilane to yield polycrystalline silicon.

21. A system used for the combined process for preparing zirconium oxide and methyl chlorosilane according to any one of claims 1 to 18, including:
a zirconium oxide preparation device, which is used to prepare zirconium oxide with zircon sand, a reducing agent carbon, chlorine gas, a heat supplementing agent silicon and hydrogen chloride as raw materials, and is also used to separate gas phase products of carbon monoxide, hydrogen gas and hydrogen chloride produced during preparing zirconium oxide;
a methyl chlorosilane preparation device, which is connected with said zirconium oxide preparation device, and is used to prepare methyl chlorosilane with gas phase products of carbon monoxide, hydrogen gas and hydrogen chloride separated from said zirconium oxide preparation device as raw materials.

22. The system used for the combined process for preparing zirconium oxide and methyl chlorosilane according to claim 21, wherein,
the zirconium oxide preparation device includes a first reactor, a dechlorinator, a first cooling separator, a hydrolysis tank, an evaporator, a crystallizer, a first solid-liquid separator, a second reactor, and a scrubbing tower,
the methyl chlorosilane preparation device includes a third reactor, a fourth reactor, and a fifth reactor;
said first reactor is used to mix and heat zircon sand, a reducing agent carbon, chlorine gas, a heat supplementing agent silicon, and hydrogen chloride, allow zircon sand, the reducing agent carbon, and chlorine gas to react to generate zirconium tetrachloride, silicon tetrachloride and carbon monoxide; and allow the heat supplementing agent silicon, chlorine gas, hydrogen chloride to react to generate silicon tetrachloride, hydrogen gas, so as to yield a first gas phase mixture;
said dechlorinator is arranged between said first reactor and said first cooling separator, and said dechlorinator is connected with said first reactor and said first cooling separator, respectively; alternatively, said dechlorinator is arranged in said first reactor, and separates a first reaction chamber provided in the first reactor from an outlet of the first reactor, and the dechlorinator is used to remove chlorine gas, hydrogen chloride in the first gas phase mixture by using silicon power therein;
said first cooling separator is connected with said first reactor, and is used to cool the introduced first gas phase mixture from which hydrogen chloride and chlorine have been removed, so as to separate the crude zirconium tetrachloride solid and produce the first gas phase mixture without crude zirconium tetrachloride solid;
said hydrolysis tank is connected with said first cooling separator, and said crude zirconium tetrachloride solid is introduced into the hydrolysis tank and then is hydrolyzed to generate zirconium oxychloride, so as to yield a hydrolysis mixture;
said evaporator is connected with said hydrolysis tank, and said hydrolysis mixture is introduced into the evaporator for evaporation;
said crystallizer is connected with said evaporator, and the hydrolysis mixture after evaporation is introduced into the crystallizer for crystallization;
said first solid-liquid separator is connected with said crystallizer, and the hydrolysis mixture after crystallization is introduced into the first solid-liquid separator for solid-liquid separation, so as to yield solid zirconium oxychloride;
said second reactor is connected with said first solid-liquid separator, and solid zirconium oxychloride is introduced into the second reactor and heated to yield zirconium oxide;
said scrubbing tower is connected with said first cooling separator, and the first gas phase mixture from which the crude zirconium tetrachloride solid has been removed is scrubbed by using silicon tetrachloride as a scrubbing solution to recovery silicon tetrachloride liquid, so as to yield a second gas phase mixture comprising carbon monoxide and hydrogen gas;
said third reactor is connected with said scrubbing tower, and said second gas phase mixture is introduced into the third reactor, and is pressurized and heated to make react and generate methanol, so as to yield a third gas phase mixture;
said fourth reactor is connected with said third reactor, said third gas phase mixture is introduced into the fourth reactor; hydrogen chloride is introduced into the fourth reactor; and both of them is heated to make methanol react with hydrogen chloride and to generate methane chloride, so as to yield a fourth gas phase mixture;
said fifth reactor is connected with said fourth reactor, said fourth gas phase mixture is introduced into the fifth reactor, silicon powder is introduced into the fifth reactor, and both of them is heated to make methane chloride react with silicon powder and to generate methyl chlorosilane, so as to yield a fifth gas phase mixture.

23. The system used for the combined process for preparing zirconium oxide and methyl chlorosilane according to claim 22, wherein said methyl chlorosilane preparation device further includes:
a hydrogen pipeline connected with an inlet of said third reactor, wherein said hydrogen pipeline is used for introducing hydrogen gas into the third reactor, and said hydrogen pipeline is provided with a first valve;
a hydrogen chloride pipeline connected with an inlet of said first reactor, wherein said hydrogen chloride pipeline is used for introducing hydrogen chloride into the first reactor, and said hydrogen chloride pipeline is provided with a second valve;
a hydrocarbon detector for detecting the molar ratio of carbon to hydrogen in the gases introduced into said third reactor;
a controller for receiving a molar ratio value of carbon to hydrogen in the gases in said third reactor detected by said hydrocarbon detector, when the molar ratio of carbon to hydrogen detected by the hydrocarbon detector is greater than a preset molar ratio of carbon to hydrogen, the controller open the first valve to introduce hydrogen gas into the third reactor, until the detected molar ratio of carbon to hydrogen is equal to the preset molar ratio of carbon to hydrogen, and then the controller close the first valve; when the molar ratio of carbon to hydrogen detected by the hydrocarbon detector is less than the preset molar ratio of carbon to hydrogen, the controller close the second valve to reduce the amount of hydrogen chloride introduced into a first reactor, until the detected molar ratio of carbon to hydrogen is equal to the preset molar ratio of carbon to hydrogen, and then the controller open the second valve.

24. The system used for the combined process for preparing zirconium oxide and methyl chlorosilane according to claim 22 or 23, wherein said methyl chlorosilane preparation device further includes:
a stripping tower, wherein a gas outlet of said stripping tower is connected with the inlet of said fourth reactor,
an inlet of said stripping tower is connected with said evaporator, and gas phase products evaporated by the evaporator is introduced into the stripping tower to strip hydrogen chloride, and the stripped hydrogen chloride is introduced into said fourth reactor as a source of hydrogen chloride; and/or,
the inlet of said stripping tower is connected with said crystallizer, and gas phase products crystallized by the crystallizer is introduced into the stripping tower to strip hydrogen chloride, and the stripped hydrogen chloride is introduced into said fourth reactor as a source of hydrogen chloride.

25. The system used for the combined process for preparing zirconium oxide and methyl chlorosilane according to claim 24, wherein said methyl chlorosilane preparation device further includes:
a heat exchanger, which is connected with said stripping tower and also connected with said evaporator, and the gas phase products produced by evaporating the hydrolysis mixture through the evaporator is introduced into the heat exchanger as a heat source, and the hydrolysis mixture is introduced into the heat exchanger for raising temperature by heat exchange, and then the gas phase products produced by evaporating the hydrolysis mixture are introduced into the heat exchanger for lowering temperature by heat exchange, after that the gas phase products are introduced into the stripping tower for stripping.

26. The system used for the combined process for preparing zirconium oxide and methyl chlorosilane according to claim 24, wherein said methyl chlorosilane preparation device further includes:
a cooling separator on the top of the stripping tower, wherein an inlet of the cooling separator on the top of the stripping tower is connected with the gas outlet of the stripping tower, a liquid outlet of the cooling separator on the top of the stripping tower is connected with the inlet on the top of the stripping tower, and a gas outlet of the cooling separator on the top of the tower is connected with said fourth reactor, and the cooling separator on the top of the stripping tower is used for cooling and separating water, and the cooled and separated water flows back into the stripping tower, and hydrogen chloride from which water has been removed flows into the fourth reactor.

27. The system used for the combined process for preparing zirconium oxide and methyl chlorosilane according to any one of claims 22, 23, 25, and 26, wherein said zirconium oxide preparation device further includes:
a second solid-liquid separator, wherein an inlet of said second solid-liquid separator is connected with an outlet of said hydrolysis tank, an outlet of the second solid-liquid separator is connected with an inlet of said evaporator, and the hydrolysis mixture through the hydrolysis tank is introduced into the second solid-liquid separator for performing solid-liquid separation to remove solid impurities, and then flows into the evaporator.

28. The system used for the combined process for preparing zirconium oxide and methyl chlorosilane according to any one of claims 22, 23, 25, and 26, wherein said zirconium oxide preparation device further includes:
a first cooler, which is arranged between said scrubbing tower and said third reactor, wherein an inlet of said first cooler is connected with a gas outlet of the scrubbing tower, a gas outlet of the first cooler is connected with an inlet of the third reactor, and the first cooler is used for cooling the second gas phase mixture to separate the silicon tetrachloride liquid, so as to yield purified second gas phase products.

29. The system used for the combined process for preparing zirconium oxide and methyl chlorosilane according to claim 28, wherein a liquid outlet of said first cooler is connected with the inlet of said first cooling separator, and the silicon tetrachloride liquid separated from the second gas phase mixture is introduced into the first cooling separator as a cold source to cool the first gas phase mixture, so as to separate the crude zirconium tetrachloride solid; and/or,
a liquid outlet of said first cooler is connected with an inlet of the scrubbing tower, and the silicon tetrachloride liquid separated by cooling the second gas phase mixture is introduced into the scrubbing tower for scrubbing to recover silicon tetrachloride.

30. The system used for the combined process for preparing zirconium oxide and methyl chlorosilane according to any one of claims 22, 23, 25, 26, and 29, wherein said methyl chlorosilane preparation device further includes:
a second cooler connected with said third reactor, wherein the third gas phase mixture enters said second cooler for cooling to yield crude methanol;
a rectification tower arranged between said second cooler and said fourth reactor, wherein the rectification tower is connected with the second cooler and the fourth reactor respectively, and crude methanol is introduced into the rectification tower for purification to yield purified third gas phase products.

31. The system used for the combined process for preparing zirconium oxide and methyl chlorosilane according to any one of claims 22, 23, 25, 26, and 29, wherein said methyl chlorosilane preparation device further includes:
a scrubbing and cooling tower connected with said fourth reactor, wherein the fourth gas phase mixture is entered into said scrubbing and cooling tower and water is used as a scrubbing solution for scrubbing and cooling to remove methanol and hydrogen chloride;
a drying tower arranged between said scrubbing and cooling tower and said fifth reactor, wherein the drying tower is used to dry and remove a by-product dimethyl ether during reaction of water, methanol and hydrogen chloride for generating methyl chlorosilane, so as to yield purified fourth gas phase products.

32. The system used for the combined process for preparing zirconium oxide and methyl chlorosilane according to any one of claims 22, 23, 25, 26, and 29, wherein a liquid outlet of said first solid-liquid separator is connected with an inlet of said hydrolysis tank, and the liquid in the first solid-liquid separator flows into the hydrolysis tank.

33. A system used for the combined process for preparing zirconium oxide, methyl chlorosilane and polycrystalline silicon according to claim 19 or 20, wherein, besides the system used for the combined process for preparing zirconium oxide and methyl chlorosilane according to any one of claims 21, 22, 23, 25, 26, 29, it further includes:
a polycrystalline silicon preparation device, which is connected with said zirconium oxide preparation device and is used for preparing polycrystalline silicon by using the silicon tetrachloride separated by said zirconium oxide preparation device as a raw material.
